(19) United States
(12) Patent Application Publication
(10) Pub. No.: US 2012/0100230 A1
(43) Pub. Date: Apr. 26, 2012

(54) Systems, Devices, and/or Methods for Managing Crops

(75) Inventors: Kenneth Harrison, Madison, VA (US); Robert Cooke, Afton, VA (US)

(73) Assignee: DHARMA IP, LLC, Charlottesville, VA (US)

(21) Appl. No.: 13/252,241

(22) Filed: Oct. 4, 2011

Related U.S. Application Data
(60) Provisional application No. 61/394,839, filed on Oct. 20, 2010.

(51) Int. Cl. A01N 59/00; A01P 1/00

(52) U.S. Cl. 424/722

(57) ABSTRACT

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, applying a treatment composition comprising or derived from a molecular matrix-residing chlorine dioxide composition.

### CROSS-REFERENCES TO RELATED APPLICATIONS

This application claims priority to pending U.S. Provisional Patent Application 61/394,839 (Attorney Docket 1099-041), filed 20 Oct. 2010.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 graphs chlorine dioxide concentration versus time for a series of polymer gels for Example 3;

FIG. 2 graphs chlorine dioxide concentration versus time for a series of polymer gels for Example 4;

FIG. 3 is a block diagram of an exemplary embodiment of a method 3000;

FIG. 4 is a graph of an exemplary embodiment's ability to retain ClO2;

FIG. 5 is a graph of an exemplary embodiment's ability to retain ClO2;

FIG. 6 is a table describing specifics of individual examples;

FIG. 7 is a flowchart of an exemplary embodiment of a method 7000;

FIG. 8 is a perspective view of an exemplary embodiment of a packaging format/delivery system;

FIG. 9 is a perspective view of an exemplary embodiment of a packaging format/delivery system;

FIG. 10 is a flowchart of an exemplary embodiment of a method; and

FIG. 11 is a graph of an exemplary embodiment's ability to release ClO2.

### DETAILED DESCRIPTION

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to, applying a treatment composition comprising or derived from a molecular matrix-residing chlorine dioxide composition.

Certain exemplary embodiments can provide for treating a harvested crop with a solution of chlorine dioxide derived from an aqueous-based dilution of a molecular matrix-residing chlorine dioxide composition comprising components that are food safe and/or environmentally acceptable, in an amount effective to eliminate or reduce the re-distribution and/or transmission of pathogens and/or spoilage organisms, fungi, etc., on the crop and/or processing and/or handling equipment.

Certain exemplary embodiments can provide a method for treating harvested crops (at least some of which can be edible by humans, livestock, mammals, and/or animals, etc.) (e.g., fruits, vegetables, seeds, spices, nuts, and/or flowers, etc.) to minimize the re-distribution and/or transmission of pathogens and/or spoilage organisms, e.g., fungi, such as Botrytis cinerea, various species of the genera Alternaria, Aspergillus, Cladosporium, Colletotrichum, Phomopsis, Fusarium, Penicillium, Phoma, Phytophthora, Pythium and Rhizopus spp., Ceratocystis fimbriata, Rhizoctonia solani, and/or Sclerotinia sclerotiorum, mildews, parasites, and/or bacteria, such as Erwinia carotovora, Pseudomonas spp., Corynebacterium, Xanthomonas campestris, and/or lactic acid bacteria, from adhering to soil, infested crops, crop surfaces, and/or processing and/or handling equipment, etc., potentially including the disinfection of certain and/or predetermined volumes of water used for post-harvest washing, handling, and/or cooling of the crop, and/or as a component of treatment(s) applied to some crops prior to packing and/or shipping, such as wax spray and/or coating treatments. Certain exemplary embodiments can provide a method of utilizing chlorine dioxide, either as a solution that can be derived from the dilution of a molecular matrix-residing chlorine dioxide composition comprising components that are food safe and/or environmentally acceptable, or as a gas that can be derived by direct release to the air from a molecular matrix-residing chlorine dioxide composition.

Broadly, certain exemplary gel and solid gel compositions can be made by absorbing substantially byproduct-free and FAC-free, pure aqueous chlorine dioxide solution in a superabsorbent or water-soluble polymer that is non-reactive with chlorine dioxide in a substantially oxygen-free environment. As tested thus far, product gel retains the chlorine dioxide concentration at 80% or higher for at least 6 months at room temperature.

Certain exemplary gel and solid gel compositions can retain chlorine dioxide molecules in an inert and innocuous solid matrix such as a gel or tablet. Such a matrix can limit the mobility of the thus-entrapped molecules, making them less susceptible to mechanical shock, protects against UV or IR radiation, and/or can limit air/oxygen penetration. The gel typically should not have microbubbles or air globules present, and preferably the amount of polymer material required should be sufficiently small so as to make the resulting product cost-effective. Any decomposition that does occur should preferably yield only harmless chloride ion and oxygen. For example:

ClO₂ (aq. gel)+organics, impurities→ClO2⁻ (aq. gel)

ClO₂⁻ (aq. gel)→Cl⁻+O₂

The composition may also comprise a tablet in an alternate embodiment of a solid gel composition. Such a tablet is created by substantially the same method as for the gel; however, a greater proportion of the superabsorbent polymer is used, e.g., ˜50 wt. %, with ˜50 wt. % ClO2 solution added.

The superabsorbent polymer should not be able to undergo an oxidation reaction with chlorine dioxide, and should be able to liberate chlorine dioxide into water without any mass transfer resistance. Nor should byproduct be releasable from the gel in contact with fresh water. Exemplary polymers may comprise at least one of a sodium salt of poly(acrylic acid), a potassium salt of poly(acrylic acid), straight poly(acrylic acid), poly(vinyl alcohol), and other types of cross-linked polyacrylates, such as polyacrylimide and poly(chloro-trimethylaminoethyl acrylate), each being preferably of pharmaceutical grade. It is believed that sodium salts are preferable to potassium salts for any potential byproduct release, although such a release has not been observed. The amount of polymer required to form a stable gel is in the order of sodium and potassium salts of poly(acrylic acid)<straight poly(acrylic acid)<poly(vinyl alcohol). The order of stability is in reverse order, however, with very little difference among these polymer types.

### Molecular Matrix-Residing Chlorine Dioxide—Gels

The gel can be formed by mixing a mass of the polymer into the aqueous chlorine dioxide solution in an amount preferably less than 5-10%, most preferably in range of approximately 0.5-5%, and stirring sufficiently to mix the components but sufficiently mildly so as to minimize the creation of agitation-produced bubbles. Gelling efficiency varies among the polymers, with the poly(acrylic acid) salts (Aridall and ASAP) forming gels more quickly with less polymer, a ratio of 100:1 solution:resin sufficient for making a stable gel; straight poly(acrylic acid) requires a ratio of 50:1 to make a similarly stable gel. The stabilities here refer to mechanical and structural, not chemical, stability.

The gelling process typically takes about 0.5-4 min, preferably 2 min, with a minimum time of mixing preferable. Gels can be produced without mixing; however, mild agitation assists the gelling process and minimizes gelling time. It has been found that 1 g of polymer can be used with as much as 120 g of 2000-ppm pure chlorine dioxide solution. Concentrations of at least 5000 ppm are achievable.

Preferably the mixing is carried out in a substantially air/oxygen-free environment in a closed container, possibly nitrogen-purged. Storage of the formed gel should be in sealed containers having UV-blocking properties is preferred, such containers comprising, for example, UV-blocking amber glass, opaque high-density polyethylene, chlorinated poly(vinyl chloride) (CPVC), polytetrafluoroethylene (PTFE)-lined polyethylene, cross-linked polyethylene, polyvinyl chloride, and polyvinylidenefluoride (PVDF), although these are not intended to be limiting.

The gel was found to be very effective in preserving chlorine dioxide concentration for long periods of time, in sharp contrast to the 1-2 days of the aqueous solution. The clean color of the gel is retained throughout storage, and did not substantially degas as found with aqueous solutions of similar concentration. For example, a 400-ppm aqueous solution produces a pungent odor that is not detectable in a gel of similar concentration. The straight PAA gels made from Carbopol (Polymer C; Noveon, Inc., Cleveland, Ohio) were found to achieve better preservation than the PAA salt types. Additional resins that may be used include, but are not intended to be limited to, Aridall and ASAP (BASF Corp., Charlotte, N.C.), and poly(vinyl alcohol) (A. Schulman, Inc., Akron, Ohio).

The liberating of aqueous chlorine dioxide from the gel material is performed by stirring the gel material into deionized water, and sealing and agitating the mixing vessel, for example, for 15 min on a low setting. Polymer settles out in approximately 15 min, the resulting supernatant comprising substantially pure aqueous chlorine dioxide. The gellant is recoverable for reuse.

Aqueous chlorine dioxide is liberated from a tablet by dissolving the tablet into deionized water and permitting the polymer to settle out as a precipitate.

The resulting aqueous chlorine dioxide may then be applied to a target, such as, but not intended to be limited to, water, wastewater, or a surface.

In order to minimize decomposition, both spontaneous and induced, the components of the gel and solid gel composition should be substantially impurity-free. Exposure to air/oxygen and UV and IR radiation should be minimized, as should mechanical shock and agitation.

Laboratory data are discussed in the following four examples.

### Example 1

Two types of polymer, the sodium and potassium salts of poly(acrylic acid), were used to form gels. The aqueous chlorine dioxide was prepared according to the method of the '861 and '135 patents, producing a chlorine dioxide concentration of 4522 mg/L, this being diluted as indicated.

The gels were formed by mild shaking for 2 min in an open clock dish, the gels then transferred to amber glass bottles, leaving minimum headspace, sealed, and stored in the dark. The aqueous controls were stored in both clear and amber bottles. After 3 days it was determined that the gels retained the original color and consistency, and were easily degelled. Table 1 provides data for 3 and 90 days, illustrating that little concentration loss occurred. The samples after 3 days were stored under fluorescent lighting at approximately 22° C.

TABLE 1
Chlorine Dioxide Gels in 3- and 90-
Day Storage, Concentrations in ppm

| | | | | | ClO2 | ClO2 | |
|---|---|---|---|---|---|---|---|
| | | ClO2 | Polymer | Initial | Conc. | Conc. | |
| | | Amt. | Amt. | ClO2 | After 3 | After 90 | Prod. |
| | Container | (ml) | (g) | Conc. | Days | Days | Form |
| Aqueous | Clear | 35 | — | ~420 | ~60 | ~0 | Soln. |
| Soln. | Bottle | | | | | | |
| Aqueous | Amber | 35 | — | ~420 | ~370 | ~70 | Soln. |
| Soln. | Bottle | | | | | | |
| Polymer | Amber | 35 | 0.25 | ~400 | ~390 | ~380 | Gel |
| BA1-1 | Bottle | | | | | | |
| Polymer | Amber | 35 | 0.30 | ~380 | ~350 | ~350 | Gel |
| BA1-2 | Bottle | | | | | | |
| Polymer | Amber | 35 | 0.25 | ~380 | ~350 | ~330 | Gel |
| BA2-1 | Bottle | | | | | | |
| Polymer | Amber | 35 | 0.30 | ~380 | ~360 | ~355 | Gel |
| BA2-2 | Bottle | | | | | | |

BA1: Sodium polyacrylate, ASAP ™ (BASF)
BA2: Potassium polyacrylate, Aridall ™ (BASF)

From these data it may be seen that, even when stored in a tightly sealed, amber bottle, the aqueous solution loses strength rapidly, although the amber bottle clearly provides some short-term alleviation of decomposition.

Also, even with a 0.71% proportion of gelling material, a stable gel was formed. The gels, in the order presented in Table 1, retained 97.4, 100, 94.3, and 98.6% of their strength at 3 days after 90 days. The two polymers provided essentially equal effectiveness. The gels apparently protected against UV-mediated decomposition. The gels are also far more effective in preserving chlorine dioxide concentration.

The gels were shown to preserve their original color during the storage period. Analysis after 90 days proved that the degelled solution contained only chlorine dioxide and a very small amount of chloride ion.

### Example 2

Gels formed by five different polymers, each having their formed gels stored in clear and amber containers, were compared when stored under different conditions. Table 2 provides the results of these experiments.

TABLE 2

| # of Days | 10 | 14 | 21 | 28 | 32 | 39 | 51 | 102 |
|---|---|---|---|---|---|---|---|---|
| CONTROL 1 | 407 | 414 | 380 | 332 | 312 | 282 | 288 | 277 |
| STDEV | 0.0 | 11.7 | 12 | 5.9 | 11.7 | 5.9 | 5.9 | 6.6 |
| CONTROL 2 | 332 | 271 | 278 | 261 | 265 | 292 | 282 | 280 |
| STDEV | 11.7 | 23.5 | 12 | 5.9 | 10.2 | 11.7 | 15.5 | 10.0 |
| CONTROL 3 | 286 | 241 | 229 | 225 | 221 | 233 | 225 | 219 |
| STDEV | 0.0 | 0.0 | 0.0 | 6.6 | 6.6 | 6.6 | 6.6 | 5.9 |
| HALF | 331 | 292 | 280 | 235 | 254 | 263 | 205 | 144 |
| BOTTLE | | | | | | | | |
| STDEV | 25.7 | 11.6 | 9 | 10.4 | 10.2 | 12.6 | 7.8 | 7.1 |
| Polymer A | 257 | 248 | 236 | 214 | 208 | 208 | 201 | 197 |
| STDEV | 12.8 | 7.4 | 7 | 14.8 | 6.4 | 9.8 | 7.4 | 8.8 |
| Polymer B | 228 | 216 | 208 | 196 | 198 | 194 | 192 | 184 |
| STDEV | 0.0 | 0.0 | 7 | 6.9 | 12.0 | 6.9 | 12.0 | 6.5 |
| Polymer C-1 | 317 | 283 | 278 | 266 | 270 | 278 | 270 | 271 |
| STDEV | 7.4 | 12.8 | 7 | 7.4 | 11.1 | 7.4 | 12.9 | 10.2 |
| Polymer C-2 | 287 | 291 | 287 | 261 | 257 | 259 | 257 | 254 |
| STDEV | 7.4 | 7.4 | 7 | 7.4 | 0.0 | 3.7 | 0.0 | 4.9 |
| PPM lost due | 46 | 31 | 49 | 36 | 43 | 59 | 56 | 61 |
| to separation | | | | | | | | |
| of polymer | | | | | | | | |
| (CONTROL | | | | | | | | |
| 2 − | | | | | | | | |
| CONTROL 3) | | | | | | | | |
| Average = 48 | | | | | | | | |

CONTROL 1: Full amber bottle with polymer (no agitation)
CONTROL 2: Full amber bottle prepared with polymer samples (agitated for 15 min)
CONTROL 3: Full amber bottle prepared with polymer samples (agitated for 15 min) and analyzed with polymer samples (diluted and agitated for 15 min)
HALF: Half-filled amber bottle
POLYMER A: Sodium polyacrylate, ASAP (BASF); full amber bottle with 0.25 g ASAP (agitated 15 min for preparation and diluted and agitated 15 min for analysis)
POLYMER B: Potassium polyacrylate; full amber bottle with 0.30 g Aridall (BASF) (agitated 15 min for preparation and diluted and agitated 15 min for analysis)
CARBOPOL C-1: Poly(acrylic acid); full amber bottle with 0.50 g Carbopol ® 974 (Noveon)(agitated 15 min for preparation and diluted and agitated 15 min for analysis)
CARBOPOL C-2: Poly(acrylic acid); Full amber bottle with 0.75 g Carbopol ® 971 (Noveon)(agitated 15 min for preparation and diluted and agitated 15 min for analysis

The half-bottle results indicate that stability was significantly lower than in full-bottle samples under substantially identical preparation and storage conditions, the difference being even more pronounced with longer storage times, illustrating the decomposition effect triggered by gas-phase air. Even in the half-bottle gels, however, storage effectiveness is still 100-200 times that of conventional solution storage.

### Example 3

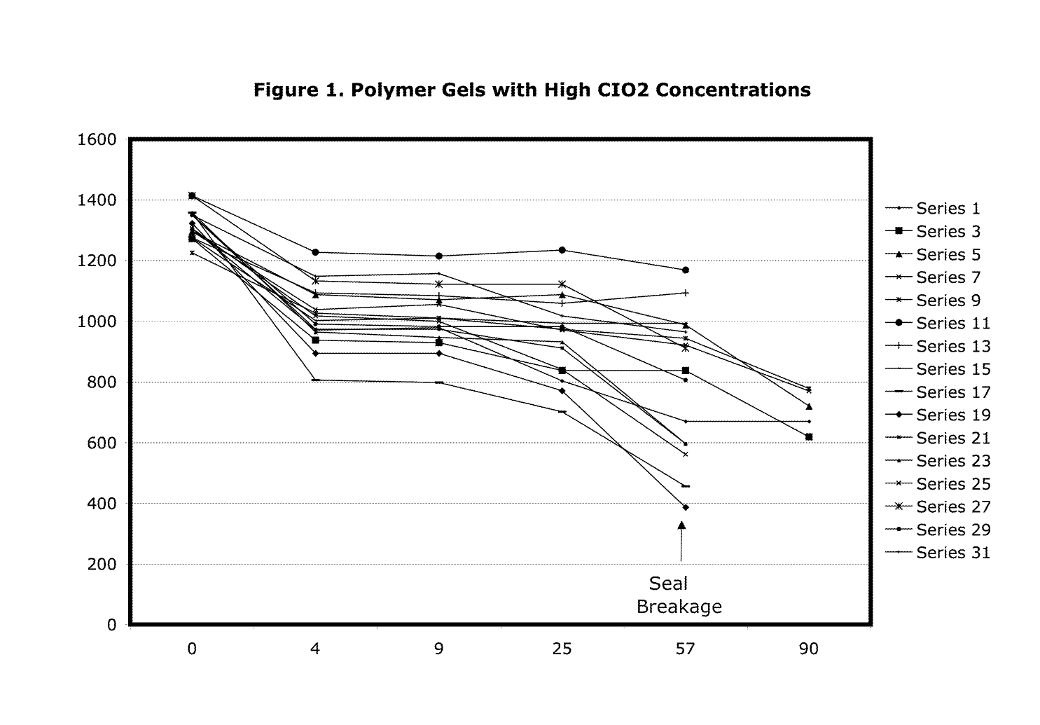

High-concentration (1425 ppm) aqueous chlorine dioxide was used to form polymer gels as listed in Table 3 in this set of experiments, the results of which are given in Table 4 and FIG. 1. The initial loss of concentration strength is due to dilution and procedural exposure, during preparation and analysis, to ambient air, not to decomposition based upon interaction between the polymer and the chlorine dioxide.

TABLE 3
Sample Preparation for Gel Technology (High Concentration)

| Samples | Bottle | Gellant |
|---|---|---|
| HDA | Amber | Polymer A |
| HDB | Amber | Polymer B |
| HDC | Amber | Polymer C-1 |
| HDD | Amber | Polymer C-2 |
| HDE | Amber | Polymer C-3 |
| HDF | Amber | Control 1 |
| HDG | Amber | Control 2 |
| HDH | Clear | Control 3 |
| HDI | Clear | Polymer A |
| HDJ | Clear | Polymer B |
| HDK | Clear | Polymer C-1 |
| HDL | Clear | Polymer C-2 |
| HDM | Clear | Polymer C-3 |
| HDN | Clear | Control 1 |
| HDO | Clear | Control 2 |
| HDP | Clear | Control 3 |

Note:
All sample bottles are full, and stored at room temperature under fluorescent light.

TABLE 4
ClO2 Analysis Data of ClO2 Gels

| | RT | Initial | 4 d | 9 d | 25 d | 57 d | 90 d | Series |
|---|---|---|---|---|---|---|---|---|
| HDA | 1425 | 1306 | 971 | 979 | 803 | 670 | 670 | 1 |
| | | 0 | 24 | 12 | 0 | 0 | 0 | |
| HDB | 1425 | 1272 | 937 | 929 | 837 | 837 | 619 | 3 |
| | | 0 | 0 | 12 | 00 | 0 | 24 | |
| HDC | 1425 | 1297 | 1088 | 1071 | 1088 | 988 | 720 | 5 |
| | | 12 | 24 | 0 | 24 | 24 | 24 | |
| HDD | 1425 | 1297 | 1038 | 1055 | 971 | 921 | 770 | 7 |
| | | 12 | 47 | 0 | 0 | 24 | 47 | |
| HDE | 1425 | 1225 | 1026 | 1010 | 973 | 944 | 778 | 9 |
| | | 0 | 0 | 23 | 0 | 23 | 23 | |
| HDF | 1425 | 1414 | 1227 | 1215 | 1234 | 1169 | | 11 |
| | | 17 | 17 | 0 | 0 | 0 | | |
| HDG | 1425 | 1275 | 1093 | 1084 | 1059 | 1093 | | 13 |
| | | 23 | 0 | 12 | 0 | 0 | | |
| HDH | 1425 | 1275 | 1002 | 1010 | 993 | 993 | | 15 |
| | | 23 | 12 | 23 | 0 | 0 | | |
| HDI | 1425 | 1358 | 806 | 798 | 701 | 456 | | 17 |
| | | 12 | 0 | 12 | 0 | 0 | | |
| HDJ | 1425 | 1323 | 894 | 894 | 771 | 386 | | 19 |
| | | 12 | 25 | 25 | 0 | 50 | | |
| HDK | 1425 | 1350 | 973 | 973 | 911 | 596 | | 21 |
| | | 0 | 12 | 12 | 0 | 0 | | |
| HDL | 1425 | 1358 | 964 | 946 | 932 | 596 | | 23 |
| | | 12 | 25 | 0 | 0 | 0 | | |
| HDM | 1425 | 1306 | 1017 | 999 | 841 | 561 | | 25 |
| | | 12 | 0 | 25 | 0 | 0 | | |
| HDN | 1425 | 1414 | 1133 | 1122 | 1122 | 911 | | 27 |
| | | 17 | 17 | 0 | 0 | 33 | | |
| HDO | 1425 | 1350 | 990 | 982 | 982 | 806 | | 29 |
| | | 25 | 12 | 0 | 0 | 0 | | |
| HDP | 1425 | 1350 | 1148 | 1157 | 1017 | 964 | | 31 |
| | | 25 | 12 | 0 | 0 | 25 | | |

Note:
Data in the first row for each sample are averages, while those on the second row are standard deviations. Sample designations as in Table 3.

The data indicate that the gels are quite stable for a long period of time. In most cases the gels retained their strength at 50% or higher even after 90 days, which is believed to represent a technological breakthrough.

Amber bottles are clearly more effective in preserving chlorine dioxide concentration, especially until the 60-day mark. Some late-stage decline may be attributable to seal failure, the seals used in these experiments comprising paraffin, which is known to be unreliable with regard to drying, fracture, pyrolytic evaporation, and puncture, and some of this failure was observable to the naked eye.

The high-molecular-weight polymer, poly(acrylic acid) (polymer C) was more effective than its lower-molecular-weight counterparts, the PAA salts (polymers A and B), indicating that higher-molecular-weight polymers provide better structural protection and “caging” for chlorine dioxide molecules against UV and air.

### Example 4

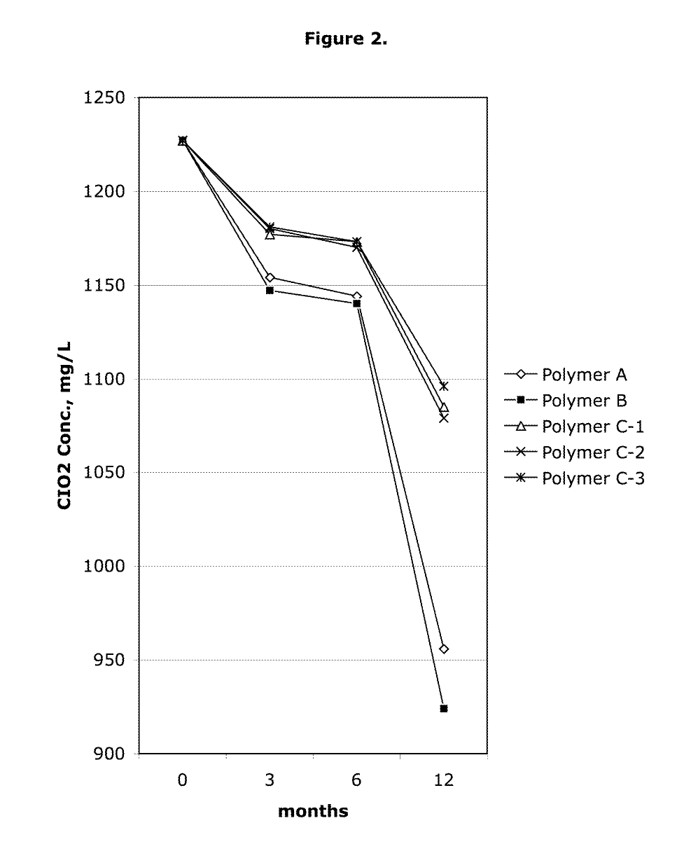

The long-term stability of the gels was tested using a set of gels prepared from three different types of water-soluble polymers. The prepared samples were kept in a ventilated cage with fluorescent light on full-time at room temperature. The gel samples were sealed tightly in amber bottles with paraffinic wax and wrapped with Teflon tapes for additional protection. Five identical samples using each polymer type were prepared, and one each was used for analysis at the time intervals shown in Table 5 and FIG. 2.

TABLE 5
Long-term Stability of Chlorine Dioxide Gels

| | 0 mo. | 3 mo. | 6 mo. | 12 mo. |
|---|---|---|---|---|
| Polymer A | 1227 | 1154 | 1144 | 956 |
| Polymer B | 1227 | 1147 | 1140 | 924 |
| Polymer C-1 | 1227 | 1177 | 1173 | 1085 |
| Polymer C-2 | 1227 | 1180 | 1170 | 1079 |
| Polymer C-3 | 1227 | 1181 | 1173 | 1096 |

Polymers A and B were added at 0.8% of the solution mass, with Polymer C added at 2%, to achieve optimal gelling concentration for each individual polymer.

All the samples indicate long-term chlorine dioxide product stability previously unachievable in the art. The gels made from polymer C were better in long-term preservation of chlorine dioxide than those made using polymers A and B, which may be attributable to its higher average molecular weight, as well as to the greater amount of polymer used per unit volume.

Therefore, it will be appreciated by one of skill in the art that there are many advantages conferred by the described embodiments. Chlorine dioxide can be preserved at least 200, and up to 10,000, times longer than previously possible in aqueous solution. Off-site manufacturing and transport now becomes possible, since the composition can be unaffected by vibration and movement, can be resistant to UV and IR radiation, to bubble formation, and to oxygen penetration, and can reduce vapor pressure. The composition can have substantially reduced risks from inhalation and skin contact.

The applications of the described embodiments are numerous in type and scale, and may include, but are not intended to be limited to, industrial and household applications, and medical, military, and agricultural applications. Specifically, uses may be envisioned for air filter cartridges, drinking water, enclosed bodies of water, both natural and manmade, cleansing applications in, for example, spas, hospitals, bathrooms, floors and appliances, tools, personal hygiene (e.g., for hand cleansing, foot fungus, gingivitis, soaps, and mouthwash), and food products. Surfaces and enclosed spaces may be cleansed, for example, against gram-positive bacteria, spores, and anthrax.

### Molecular Matrix-Residing Chlorine Dioxide—Solids

Chlorine dioxide (“ClO2”) can be an excellent disinfectant, and/or can be effective against a wide range of organisms. For example, ClO2 can provide excellent control of viruses and bacteria, as well as the protozoan parasites Giardia, Cryptosporidium, and/or amoeba Naegleria gruberi and their cysts.

In addition to disinfection, ClO2 can have other beneficial uses in water treatment, such as color, taste and odor control, and removal of iron and manganese. There are also important uses outside of water treatment, such as bleaching pulp and paper (its largest commercial use), disinfection of surfaces, and sanitization/preservation of fruits and vegetables.

ClO2 can present certain challenges, which can stem largely from its inherent physical and chemical instability. ClO2 in pure form is a gaseous compound under normal conditions. As a gas, it can be sensitive to chemical decomposition, exploding at higher concentrations and when compressed. Because ClO2 can be highly soluble in water, ClO2 can be used as a solution of ClO2 gas dissolved in water.

However, the gaseous nature of ClO2 means that it can be volatile, thus ClO2 tends to evaporate rapidly from solutions when open to the atmosphere (physical instability). This tendency can limit the practically useful concentrations of ClO2 solutions. With concentrated solutions, this rapid evaporation can generate gaseous ClO2 concentrations that can present an unpleasantly strong odor, and can pose an inhalation hazard to users. A closed container of the solution can quickly attain a concentration in the headspace of the container that is in equilibrium with the concentration in the solution. A high concentration solution can have an equilibrium headspace concentration that exceeds the explosive limits in air (considered to be about 10% by volume in air).

For these and other reasons, virtually all commercial applications to date have required that ClO2 be generated at the point of use to deal with these challenges. However, on-site generation also can have significant draw-backs, particularly in the operational aspects of the equipment and the need to handle and store hazardous precursor chemicals. It can be desirable to have additional forms of ready-made ClO2.

Certain exemplary embodiments can provide a composition of matter comprising a solid form of chlorine dioxide complexed with a cyclodextrin. When stored, a concentration of the chlorine dioxide in the composition of matter can be retained at, for example, greater than 12% for at least 14 days and/or greater than 90% for at least 80 days, with respect to an initial concentration of chlorine dioxide in said composition of matter. Certain exemplary embodiments can provide a method comprising releasing chlorine dioxide from a solid composition comprising chlorine dioxide complexed with a cyclodextrin.

Certain exemplary embodiments can provide a solid complex formed by combining ClO2 with a complexing agent such as a cyclodextrin, methods of forming the complex, and/or methods of using the complex as a means of delivering ClO2, such as essentially instantly delivering ClO2.

ClO2 is widely considered to be inherently unstable. Also, ClO2 is widely considered to be reactive with a fairly wide range of organic compounds, including glucose, the basic building block of cyclodextrins such as alpha-cyclodextrin. It is reasonable to assume that ClO2 will react with cyclodextrins in solution. Additionally, relatively impure ClO2 systems containing chlorite and/or chlorate impurities might be expected to destroy cyclodextrins due to the reactivity of chlorite/chlorate with organic compounds.

Chlorine dioxide can be generated by the method described in the OxyChem Technical Data Sheet “Laboratory Preparations of Chlorine Dioxide Solutions—Method II: Preparation of Reagent-Grade Chlorine Dioxide Solution”, using nitrogen as the stripping gas.

That method specifies the following equipment and reagents:
three-neck reaction flask, 1-liter (1)
pressure equalizing addition funnel, 125-mls (2)
gas inlet tube, with adapter (3)
gas exit adapter (4)
gas scrubbing tower, 1-liter (5)
amber reagent bottle, 1 liter (6)
gas inlet tube, without adapter (7)
ice bath (8)
flexible tubing (rubber or Tygon®)
Technical Sodium Chlorite Solution 31.25
concentrated sulfuric acid, 36N

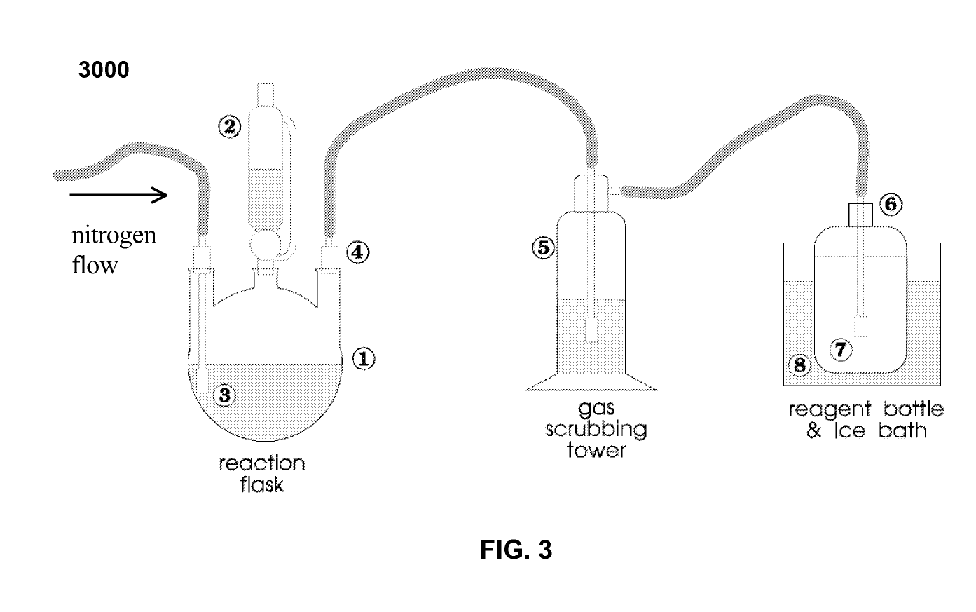

That method specifies, inter alia, the following procedure:
Assemble the generator setup as shown in FIG. 3. To ensure airtight assembly use standard taper glassware and silicon grease if possible. Rubber stoppers are an acceptable alternative.
Fill the reaction flask and gas scrubbing tower with 500 mls of approximately 2.5% (wt) NaClO2 solution. Make certain all gas inlets are submerged. (2.5% NaClO2 solution may be prepared by diluting OxyChem Technical Sodium Chlorite Solution 31.25 1:10 with DI water).
Prepare 50 mls of 10% (vol) sulfuric acid solution and place this solution in the addition funnel. WARNING: Always add acid to water; never add water to acid.
Fill the amber reagent bottle with 500 to 750 mls. of DI water and place in an ice bath.
Turn on the air flow to the generation setup (there should be bubbles in all three solutions.) If there are not, check the setup for leaks.
Once there are no leaks, slowly add the acid solution (5 to 10 mls at a time). Wait 5 minutes between additions. Continue the air flow for 30 minutes after the final addition.
Store the chlorine dioxide solution in a closed amber bottle in a refrigerator. Properly stored solutions may be used for weeks, but should be standardized daily, prior to use, by an approved method, such as Method 4500-ClO2, Standard Methods for the Examination of Water and Wastewater, 20th Ed., APHA, Washington, D.C., 1998, pp 4-73 to 4-79.

We have unexpectedly discovered that, by bubbling sufficiently pure gaseous ClO2 diluted in nitrogen (as generated by this method) at a rate of, for example, approximately 100 ml/minute to approximately 300 ml/minute, through a near-saturated solution of alpha-cyclodextrin (approximately 11% to approximately 12% w/w) in place of plain water, at or below room temperature, a solid precipitate formed. The minimum ClO2 concentration required to obtain the solid precipitate lies somewhere in the range of approximately 500 ppm to approximately 1500 ppm. A 1:1 molar ratio of ClO2 to cyclodextrin—approximately 7600 ppm ClO2 for approximately 11% alpha-cyclodextrin—is presumed to be needed in order to complex all the alpha-cyclodextrin. We believe that the use of even more ClO2 will maximize the amount of precipitate that forms. Precipitation may begin before ClO2 addition is complete, or may take up to approximately 2 to approximately 3 days, depending on the amount of ClO2 added and the temperature of the system.

Another method of preparing this solid material is as follows. A solution of alpha-cyclodextrin is prepared. That solution can be essentially saturated (approximately 11%). A separate solution of ClO2 can be prepared by the method referenced above, potentially such that it is somewhat more concentrated than the alpha-cyclodextrin solution, on a molar basis. Then the two solutions can be combined on approximately a 1:1 volume basis and mixed briefly to form a combined solution. Concentrations and volumes of the two components can be varied, as long as the resultant concentrations in the final mixture and/or combined solution are sufficient to produce the precipitate of the complex. The mixture and/or combined solution then can be allowed to stand, potentially at or below room temperature, until the precipitate forms. The solid can be collected by an appropriate means, such as by filtration or decanting. The filtrate/supernatant can be chilled to facilitate formation of additional precipitate. A typical yield by this unoptimized process, after drying, can be approximately 30 to approximately 40% based on the starting amount of cyclodextrin. The filtrate/supernatant can be recycled to use the cyclodextrin to fullest advantage.

The collected precipitate then can be dried, such as in a desiccator at ambient pressure, perhaps using Drierite™ desiccant. It has been found that the optimum drying time under these conditions is approximately 24 hours. Shorter drying times under these conditions can leave the complex with unwanted free water. Longer drying times under these conditions can result in solid containing a lower ClO2 content.

Since we have observed that the residence time of the complex in a desiccating chamber has a distinct effect on the resulting ClO2 content of the dried complex, it is expected that the use of alternate methods of isolating and/or drying the complex can be employed to alter yield rates and obtain a ClO2 cyclodextrin complex with specific properties (stability, ClO2 concentration, dissolution properties, etc.) suitable for a particular application. Lyophilization and spray-drying are examples of these kinds of alternate methods, which can dry the precipitated complex, and/or isolate the complex as a dry solid from solution-phase complex, and/or from the combined precipitate/solution mixture.

Based on methods used to form other complexes with cyclodextrins, it is believed that any of several additional methods could be utilized to form the ClO2 cyclodextrin complex. Slurry complexation, paste complexation, solid phase capture, and co-solvent systems are examples of additional preparatory options. In one unoptimized example of a modified slurry process, 11 g of solid alpha-cyclodextrin was added directly to a 100 g solution of 7800 ppm ClO2 and mixed overnight. While a majority of the cyclodextrin went into solution, approximately 20% of the powder did not. This was subsequently found to have formed a complex with ClO2 that upon isolation, contained approximately 0.8% ClO2 by weight. In one unoptimized example of a solid phase capture process, ClO2 gas was generated by the method described in the OxyChem Technical Data Sheet. The ClO2 from the reaction was first passed through a chromatography column packed with a sufficient amount of Drierite to dry the gas stream. Following this drying step, 2.0 g of solid alpha-cyclodextrin was placed in-line and exposed to the dried ClO2 in the vapor phase for approximately 5 hours. The alpha-cyclodextrin was then removed, and found to have formed a complex with ClO2 containing approximately 0.75% ClO2 by weight.

This precipitate is assumed to be a ClO2/alpha-cyclodextrin complex. Cyclodextrins are known to form complexes or “inclusion compounds” with certain other molecules, although for reasons presented above it is surprising that a stable complex would form with ClO2. Such a complex is potentially characterized by an association between the cyclodextrin molecule (the “host”) and the “guest” molecule which does not involve covalent bonding. These complexes are often formed in a 1:1 molecular ratio between host and guest, but other ratios are possible.

There are a number of reaction conditions that affect the process leading to the formation of the complex. Any of these conditions can be optimized to enhance the yield and/or purity of the complex. Several of these conditions are discussed below.

The pH at which the complexation takes place between ClO2 and cyclodextrin has been observed to affect the yield and ClO2 content of the resulting ClO2 complex. Therefore, this parameter might affect the stability and/or properties of the resulting complex. An approximately 11% alpha-cyclodextrin solution was combined with an approximately 9000 ppm ClO2 solution on a 1:1 molar basis and the pH immediately adjusted from approximately 3.5 to approximately 6.7 with approximately 10% NaOH. A control was set up in the same fashion with no pH adjustment after combining the approximately 11% cyclodextrin and approximately 9000 ppm ClO2 solution. The resulting yield of the pH adjusted preparation was approximately 60% lower than the control and had approximately 20% less ClO2 content by weight.

The temperature at which the complexation takes place between ClO2 and cyclodextrin has been observed to affect the yield and ClO2 content of the resulting ClO2 complex. Therefore, this parameter might affect the stability and/or properties of the resulting complex. An approximately 11% alpha-cyclodextrin solution was combined with an approximately 7800 ppm ClO2 solution on a 1:1 molar basis in 2 separate bottles. One of these was placed in a refrigerator at approximately 34° F. and the other was left at room temperature. Upon isolation and dry down of the resulting complexes, the refrigerated preparation produced approximately 25% more complex by weight and a lower ClO2 concentration.

The stirring rate and/or level of agitation during the formation of a ClO2 cyclodextrin complex has been observed to affect the yield and ClO2 content of the resulting ClO2 complex. Therefore, this parameter might affect the stability and/or properties of the resulting complex. An approximately 11% alpha-cyclodextrin solution was combined with an approximately 7800 ppm ClO2 solution on a 1:1 molar basis in 2 separate bottles. One of the bottles was placed on a magnetic stir plate at approximately 60 rpm, while the other remained undisturbed. After approximately 5 days, the precipitated complex from each was isolated and dried down. The preparation that was stirred resulted in an approximately 20% lower yield and approximately 10% lower ClO2 concentration by weight.

The addition of other compounds to the complexation mixture has been observed to affect the yield and/or ClO2 content of the resulting ClO2 complex. Therefore, the use of additives in the preparation process might affect the stability and/or properties of the resulting complex and/or lead to a ClO2 complex with properties tailored to a specific application. For example, we have found that very low concentrations of water soluble polymers (approximately 0.1% w/v), such as polyvinylpyrrolidone and carboxymethylcellulose, have resulted in ClO2 concentrations higher and lower, respectively, than that observed in a control preparation containing only cyclodextrin and ClO2. In both cases however, the yield was approximately 10% lower than the control. In another example, we found that the addition of approximately 0.5% acetic acid to the complexation mixture resulted in approximately 10% higher yield and approximately 40% lower ClO2 content.

When isolated and dried, the resulting solid typically has a granular texture, appears somewhat crystalline, with a bright yellow color, and little or no odor. It can be re-dissolved in water easily, and the resulting solution is yellow, has an odor of ClO2, and assays for ClO2. The ClO2 concentration measured in this solution reaches its maximum as soon as all solid is dissolved, or even slightly before. The typical assay method uses one of the internal methods of the Hach DR 2800 spectrophotometer designed for direct reading of ClO2. The solution also causes the expected response in ClO2 test strips such as those from Selective Micro Technologies or LaMotte Company. If a solution prepared by dissolving this complex in water is thoroughly sparged with N2 (also known as Nitrogen or N₂), the solution becomes colorless and contains virtually no ClO2 detectable by the assay method. The sparged ClO2 can be collected by bubbling the gas stream into another container of water.

One sample of the dried solid complex was allowed to stand in an uncovered container for approximately 30 hours before being dissolved in water, and appeared to have lost none of its ClO2 relative to a sample that was dissolved in water immediately after drying. Four portions from one batch of solid complex left in open air for periods of time ranging from approximately 0 to approximately 30 hours before being re-dissolved in water all appeared to have about the same molar ratio of ClO2 to alpha-cyclodextrin. Other batches appeared to have somewhat different ratios of ClO2 to alpha-cyclodextrin. This difference may simply reflect differences in sample dryness, but it is known that cyclodextrin-to-guest ratios in other cyclodextrin complexes might vary with differences in the process by which the complex was formed. However, samples of the present complex prepared by an exemplary embodiment tended to contain close to, but to date not greater than, a 1:1 molar ratio of ClO2 to cyclodextrin. That is, their ClO2 content approached the theoretical limit for a 1:1 complex of approximately 6.5% by weight, or approximately 65,000 ppm, ClO2. Assuming that a 1:1 molar ratio represents the ideal form of the pure complex, the ratio of ClO2 to cyclodextrin can be targeted as close to 1:1 as possible, to serve as an efficient ClO2 delivery vehicle. However, solid complexes with a net ClO2 to cyclodextrin ratio of less than 1:1 can be desirable in some cases. (We believe such a material is probably a mixture of 1:1 complex plus uncomplexed cyclodextrin, not a complex with a molar ratio of less than 1:1.)

An aqueous solution of ClO2 having such a high concentration (e.g., approaching approximately 65,000 ppm) can pose technical and/or safety challenges in handling, such as rapid loss of ClO2 from the solution into the gas phase (concentrated and therefore a human exposure risk), and/or potentially explosive vapor concentrations in the headspace of a container in which the solution is contained. The solid appears not to have these issues. Release into the gas phase is relatively slow, posing little exposure risk from the complex in open air. The lack of significant odor can be an important factor in the users' sense of safety and/or comfort in using the solid. For example, a small sample has been left in the open air for approximately 72 hours, with only an approximately 10% loss of ClO2. At such a slow rate, users are unlikely to experience irritation or be caused to feel concern about exposure. Gas-phase ClO2 concentration in the headspace of a closed container of the complex can build up over time, but appears not to attain explosive concentrations. Even solid complex dampened with a small amount of water, so that a “saturated” solution is formed, to date has not been observed to create a headspace ClO2 concentration in excess of approximately 1.5% at room temperature. It is commonly believed that at least a 10% concentration of ClO2 in air is required for explosive conditions to exist.

The freshly-prepared complex is of high purity, since it is obtained by combining only highly pure ClO2 prepared by OxyChem Method II, cyclodextrin, and water. Some cyclodextrins are available in food grade, so the complex made with any of these is suitable for treatment of drinking water and other ingestible materials, as well as for other applications. Other purity grades (technical, reagent, pharmaceutical, etc.) of cyclodextrins are available, and these could give rise to complexes with ClO2 that would be suitable for still other applications.

In certain embodiments, the solid complex can be quickly and conveniently dissolved directly in water that is desired to be treated. Alternatively, the solid can be dissolved, heated, crushed, and/or otherwise handled, processed, and/or treated to form, and/or release from the solid, a solution, such as an aqueous chlorine dioxide solution, and/or another form of ClO2, such as a ClO2 vapor, that then can be used for disinfecting surfaces, solids, waters, fluids, and/or other materials. For example, solutions of ClO2 prepared by dissolving the complex in water, either the water to be treated or an intermediate solution, can be used for any purpose known in the art for which a simple aqueous solution of comparable ClO2 concentration would be used, insofar as this purpose is compatible with the presence of the cyclodextrin. These uses can include disinfection and/or deodorization and/or decolorization of: drinking water, waste water, recreational water (swimming pools, etc.), industrial reuse water, agricultural irrigation water, as well as surfaces, including living tissues (topical applications) and foods (produce, meats) as well as inanimate surfaces, etc.

It is anticipated that the complex can be covalently bound, via the cyclodextrin molecule, to another substrate (a polymer for example) for use in an application where multiple functionality of a particular product is desired. For example, such a complex bound to an insoluble substrate can, upon contact with water, release its ClO2 into solution while the cyclodextrin and substrate remain in the solid phase.

It has been found that this solid complex ordinarily experiences a slow release of ClO2 gas into the air. Conditions can be selected such that the concentration level of the ClO2 released into the air is low enough to be safe (a condition suggested by the lack of conspicuous odor) but at a high enough concentration to be efficacious for disinfection and/or odor control in the air, and/or disinfection of surfaces or materials in contact with the air.

The solid complex can release ClO2 directly, via the gas phase, and/or via moisture that is present, into other substances. The solid can be admixed with such substances, such as by mixing powdered and/or granular solid complex with the other substances in powdered and/or granular form. The solid complex can be applied to a surface, such as skin and/or other material, either by “rubbing in” a sufficiently fine powder of the complex, and/or by holding the solid complex against the surface mechanically, as with a patch and/or bandage. The substance receiving the ClO2 from the complex can do so as a treatment of the substance and/or the substance can act as a secondary vehicle for the ClO2.

In some instances, the complex can impart different and/or useful reactivity/properties to ClO2. By changing its electronic and/or solvation environment, the reactivity of complexed ClO2 will almost certainly be quantitatively, and perhaps qualitatively, different.

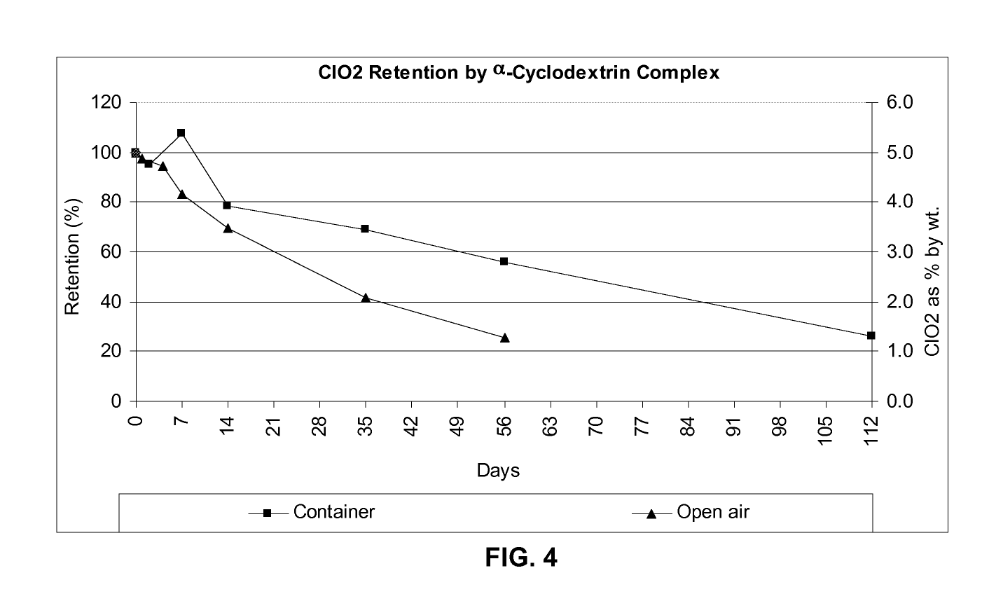

FIG. 4 illustrates the ability of an exemplary complex to retain ClO2 when stored at room temperature, either in the open air (an uncapped jar) or in a closed and/or substantially ClO2-impermeable container with relatively little headspace. It appears that ClO2 is retained somewhat more effectively in the closed, low-headspace container, and it may be possible to improve ClO2 retention further by reducing the headspace further. However, ClO2 retention is remarkable in either case, considering that the complex is an essentially waterless medium containing a reactive gaseous molecule.

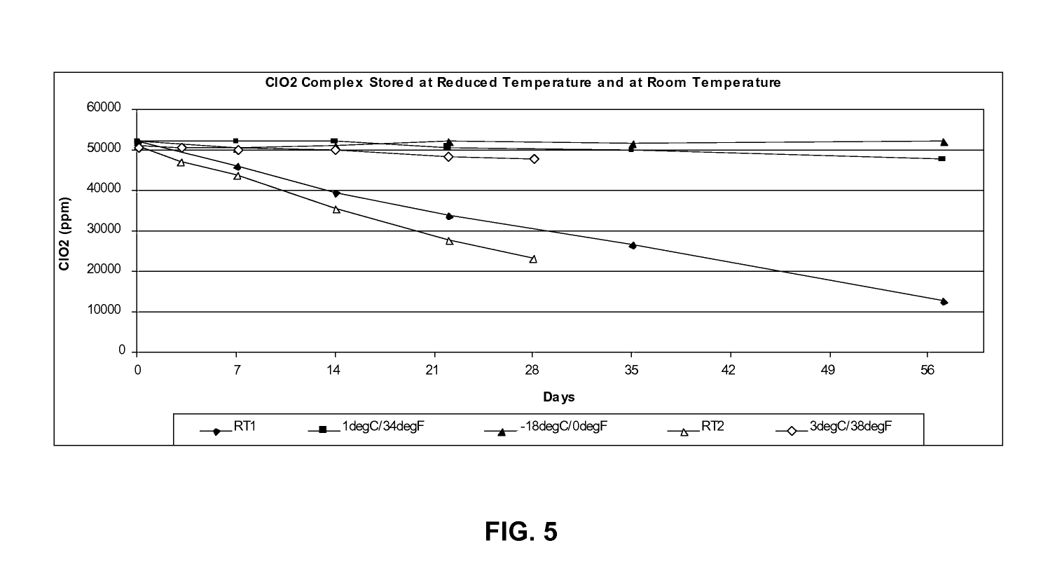

Early indications are that ClO2 retention can be greatly enhanced by cold storage. FIG. 5 illustrates retention by samples stored at room temperature (RT) (at approximately 20 C to approximately 26 C) compared to those stored in a refrigerator (at approximately 1 C and at approximately 3 C) and those stored in a freezer (at approximately −18 C). For example, to one of ordinary skill in the art, FIG. 5 illustrates that a sample stored at room temperature for 14 days, retained greater than 0 percent to greater than 65 percent, including all values and sub-ranges therebetween (e.g., 6.157, 12, 22.7, 33, 39.94, 45, etc., percent), and in fact approximately 70 percent of its original ClO2 content. Another sample, when stored at room temperature for 56 days, retained greater than 0 percent to greater than 20 percent, including all values and sub-ranges therebetween, and in fact approximately 24 percent of its original ClO2 content. As another example, FIG. 5 illustrates that a sample stored at approximately 3 C for 28 days retained greater than 0 percent to greater than 90 percent, including all values and sub-ranges therebetween, and in fact approximately 94 percent of its original ClO2 content. FIG. 5 also illustrates that a sample stored at approximately 1 C for at least 35 days retained greater than 0 percent to greater than 95 percent, including all values and sub-ranges therebetween, and in fact approximately 96 percent of its original ClO2 content. One of ordinary skill can determine additional retention amounts, percentages, and times by a cursory review of FIG. 5. While not wishing to be bound by any particular theory, these retention results might be due in part to the fact that ClO2 in the pure state, though a gas at room temperature, is a liquid at temperatures below 11 C (down to −59 C, at which temperature it freezes into a solid).

The solid complex can be packaged and/or stored in a range of forms and packages. Forms can include granulations/powders essentially as recovered from the precipitation process. The initially obtained solid complex can be further processed by grinding and/or milling into finer powder, and/or pressing into tablets and/or pucks and/or other forms known to the art. Other materials substantially unreactive toward ClO2 can be combined with the solid complex to act as fillers, extenders, binders, and/or disintegrants, etc.

Suitable packages are those that can retain gaseous ClO2 to a degree that provides acceptable overall ClO2 retention, consistent with its inherent stability, as discussed above, and/or that provide adequate protection from moisture. Suitable materials to provide high ClO2 retention can include glass, some plastics, and/or unreactive metals such as stainless steel. The final form of the product incorporating the solid complex can include any suitable means of dispensing and/or delivery, such as, for example, enclosing the solid in a dissolvable and/or permeable pouch, and/or a powder/solid metering delivery system, and/or any other means known in the art.

Other cyclodextrins: Most of the above material relates to alpha-cyclodextrin and the complex formed between it and ClO2. This is the only ClO2/cyclodextrin complex yet isolated. We believe that beta-cyclodextrin may form a complex with ClO2, which techniques readily available to us have not been able to isolate. Whereas the complex with alpha-cyclodextrin is less soluble than alpha-cyclodextrin alone, leading to ready precipitation of the complex, it may be that the ClO2/beta-cyclodextrin complex is more soluble than beta-cyclodextrin alone, making isolation more difficult. Such solubility differences are known in the art surrounding cyclodextrin complexes. Techniques such as freeze-drying may be able to isolate the complex in the future.

However indirect evidence for the complex has been observed. Beta-cyclodextrin has a known solubility in water. If the water contains a guest substance that produces a cyclodextrin complex more soluble than the cyclodextrin alone, more of the cyclodextrin will dissolve into water containing that guest than into plain water. This enhanced solubility has been observed for beta-cyclodextrin in water containing ClO2. Two separate 100 g slurries of beta-cyclodextrin solutions were prepared. The control solution contained 5% beta-cyclodextrin (w/w) in ultrapure water, and the other contained 5% beta-cyclodextrin (w/w) in 8000 ppm ClO2.

Both slurries were mixed at 200 rpm for 3 days, at which time the undissolved beta-cyclodextrin was isolated from both solutions and dried for 2 days in a desiccator. The weight of the dried beta-cyclodextrin from the ClO2 containing slurry was 0.32 g less than the control slurry indicating that a soluble complex might exist between the beta-cyclodextrin and ClO2 in solution. It is believed, by extension, that ClO2 might form complexes with gamma-cyclodextrin and/or chemically derivatized versions of the natural (alpha- (“α”), beta- (“β”), and gamma- (“γ”)) cyclodextrins. In the case of beta- and/or gamma-cyclodextrin and/or other cyclodextrins having internal cavities larger than that of alpha-cyclodextrin, it might be that the complex(es) formed with ClO2 will incorporate numbers of ClO2 molecules greater than one per cyclodextrin molecule.

Related inclusion complex formers: It is expected by extension of the observed cyclodextrin complexes that some other molecules known to form inclusion compounds will also complex ClO2. In particular, cucurbiturils are molecules known primarily for having ring structures that accommodate smaller molecules into their interior cavities. These interior cavities are of roughly the same range of diameters as those of the cyclodextrins. It is anticipated that combining the appropriate cucurbituril(s) and ClO2 under correct conditions will produce cucurbituril/ClO2 complex(es), whose utility can be similar to that of cyclodextrin/ClO2 complexes.

### EXAMPLES

### Solids

### Example 1

### Solid Complex Preparation by Generation Process

ClO2 generated by the OxyChem Method II referenced above was bubbled as a stream mixed with nitrogen, at a rate of approximately 100-300 ml per minute, into an approximately 120 mL serum bottle containing approximately 100 g of approximately 11% (by weight) alpha-cyclodextrin solution at RT. Precipitation of the complex was observed to begin within approximately 1 hour, with ClO2 ultimately reaching a concentration of approximately 7000 ppm or more in the solution. Precipitation occurred very rapidly, and over the course of approximately 10 minutes enough complex was formed to occupy a significant volume of the bottle. The bottle was capped and placed in the refrigerator to facilitate further complex formation. After approximately 1 week the solid was removed from the solution onto filter paper and dried in a desiccator with Drierite for approximately 4 days. Yield was approximately 50% (by weight of starting cyclodextrin), and ClO2 concentration in the complex was approximately 1.8%.

### Examples 2-10

### Solid Complex Preparation by Combining Solutions

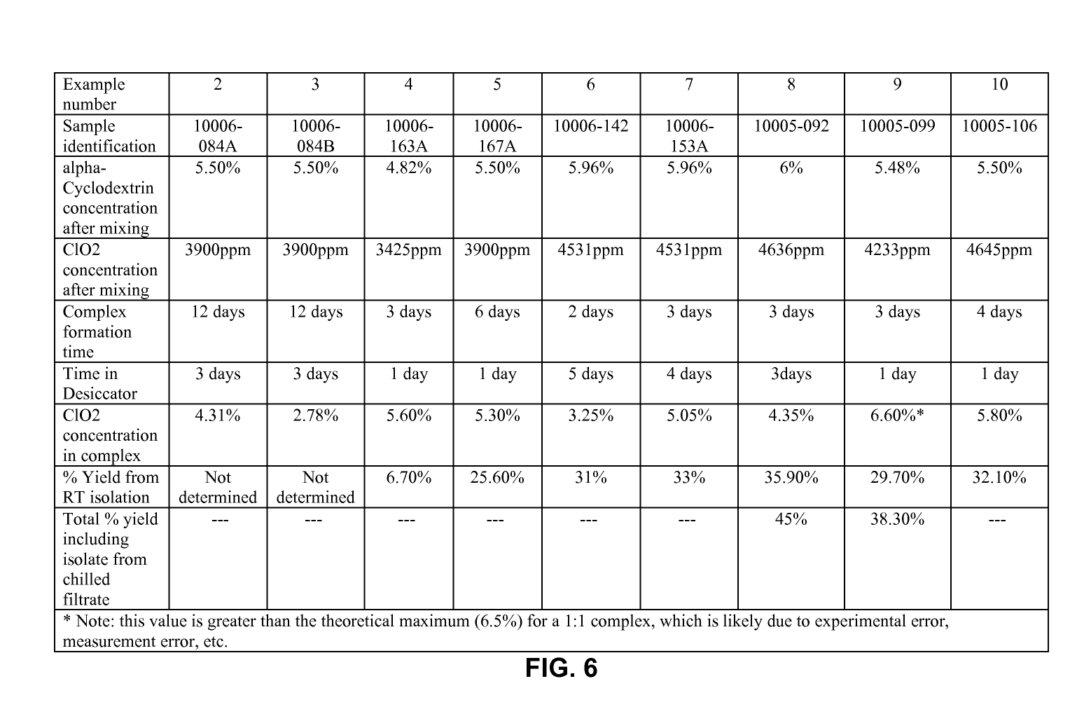

The general method used was as follows. See FIG. 6 for a table describing specifics of individual examples. A nearly saturated (approximately 11%) solution of alpha-cyclodextrin was prepared. A separate solution of ClO2 was prepared by OxyChem Method II, such that it was somewhat more concentrated than the alpha-cyclodextrin solution, on a molar basis. The two solutions were combined at approximately a 1:1 volume basis, i.e., approximately 500 ml of each, and mixed briefly to combine thoroughly. The mixture was then allowed to stand at room temperature, until the precipitate formed. Stirring during precipitation did not appear to improve the yield or quality of product. The solid was collected by filtration or decanting. In certain cases the filtrate/supernatant was chilled to facilitate formation of additional precipitate. The collected precipitate was then dried in a desiccator at ambient pressure using Drierite desiccant.

### Additional Solid Complex Examples

Other experiments showed a wide variety in initial ClO2 concentrations in freshly prepared complex. For example, in several experiments, complex formed by the combining solutions approach yielded ClO2 concentrations such as 1.8% and 0.9%. In other experiments, complex formed by the generation method in which the ClO2 was captured in an ice-chilled cyclodextrin solution yielded 0.2% ClO2.

Additional experiments at room temperature resulted in a wide variety of ClO2 retention results. For example, when complex formed by the combining solutions approach was sealed in approximately 10 ml vials with a nitrogen blanket, approximately 56% of the original ClO2 concentration was retained after 35 days, and approximately 31% was retained after 56 days. As another example, when complex formed by the generation method was left open to the air in a dark storage area, approximately 42% of the original ClO2 concentration was retained after 35 days, and approximately 25% was retained after 56 days. As yet another example, when complex formed by the generation method was sealed in approximately 10 ml clear glass vials with a nitrogen blanket and stored under white fluorescent light, approximately 13% of the original ClO2 concentration was retained after 14 days. As still another example, when complex formed by the generation method was stored in an approximately 2 ounce jar covered with Parafilm, approximately 6% of the original ClO2 concentration was retained after 59 days.

Further experiments at refrigerator temperature (approximately 1 degree C.) also resulted in a wide variety of ClO2 retention results with respect to the original ClO2 concentration, including 91% after 30 days, 95% after 85 days, and 100% after 74 days.

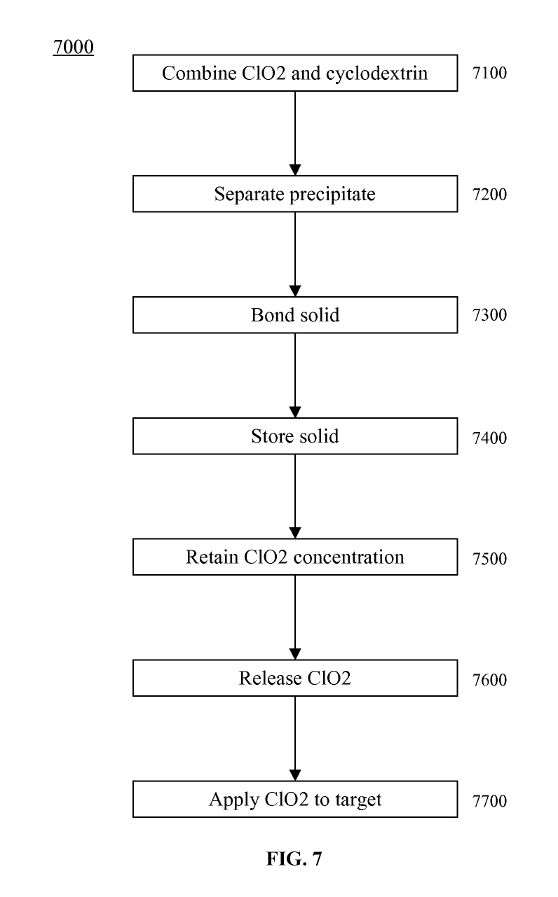

FIG. 7 is a flowchart of an exemplary embodiment of a method 7000. At activity 7100, a solution of cyclodextrin can be combined with a solution of chlorine dioxide, such as on an approximately 1:1 molar basis, to form a combined solution, which can form and/or precipitate a solid and/or solid complex comprising the chlorine dioxide complexed with the cyclodextrin. At activity 7200, the precipitate can be separated from the combined solution, and/or the combined solution and/or precipitate can be dried, lyophilized, and/or spray-dried. At activity 7300, the resulting solid complex can be bonded, such as via covalent bonding, to, for example, a substrate and/or a polymer. Bonding of the complex via the cyclodextrin to a substrate might be possible at this stage, but it might be more feasible to bond the cyclodextrin to the substrate before forming the complex with ClO2. At activity 7400, the solid complex can be stored, such as in a closed and/or substantially ClO2-impermeable container, at a desired temperature, such as at ambient, room, refrigerated, and/or heated temperature. At activity 7500, the solid complex can retain a concentration of chlorine dioxide, with respect to an initial concentration of chlorine dioxide in the complex, at, for example, greater than 60% for at least 42 days. At activity 7600, the chlorine dioxide can be released from the complex, such as by dissolving the complex in water. At activity 7700, the chlorine dioxide can be applied to a target, such as a volume of liquid, such as water, a fluid, and/or a solid, such as a surface.

### Applications for Molecular Matrix-Residing Chlorine Dioxide Compositions

For highly perishable commodities, such as berry fruits, tomatoes, squash, and/or peaches, as much as 30 percent of a typical harvested crop might be lost to post harvest diseases and/or spoilage before it reaches consumers. Losses for other fruits and/or vegetables, although not as high, can be significant. Often, investments made to save food after harvest provide greater returns for growers, distributors, retailers, and/or consumers, and frequently are less harmful to the environment, than equivalent investments to increase production.

As highlighted in Table 6, there are many types of post harvest disorders and/or infectious diseases and/or spoilage that affect fresh fruits and/or vegetables.

TABLE 6
Common Post-harvest Diseases of Fruits and Vegetables

| Commodity and Disease | Pathogen* |
|---|---|
| Apples | |
| Blue mold | Penicillium expansum (f) |
| Gray mold | Botrytis cinerea (f) |
| Black rot | Physalospora obtusa (f) |
| Bitter rot | Glomerella cingulata (f) |
| Citrus Fruits | |
| Citrus Canker | Xanthomonas axonopodis (b) |
| Grapes and small berry fruit | |
| Blue mold | Penicillium sp. (f) |
| Gray mold | Botrytis cinerea (f) |
| Rhizopus rot | Rhizopus stolonifer (f) |
| Potatoes | |
| Fusarium tuber rot | Fusarium spp. (f) |
| Wet rot | Pythium sp. (f) |
| Bacterial soft rot | Erwinia spp. (b) |
| Slimy soft rot | Clostridium spp. (b) |
| Peaches and plums | |
| Brown rot | Monilinia fructicola (f) |
| Rhizopus rot | Rhizopus stolonifer (f) |
| Gray mold | Botrytis cinerea (f) |
| Blue mold | Penicillium sp. (f) |
| Alternaria rot | Alternaria sp. (f) |
| Gilbertella rot | Gilbertella persicaria (f) |
| Sweet Potatoes | |
| Bacterial soft rot | Erwinia chrysanthemi (b) |
| Black rot | Ceratocystis fimbriata (f) |
| Ring rot | Pythium spp. (f) |
| Java black rot | Diplodia gossypina (f) |
| Fusarium surface rot | Fusarium oxysporum (f) |
| Fusarium root and stem rot | Fusarium solani (f) |
| Rhizopus soft rot | Rhizopus nigricans (f) |
| Charcoal rot | Marcrophomina sp. (f) |
| Tomatoes and peppers | |
| Alternaria rot | Alternaria alternata (f) |
| Buckeye rot | Phytophthora sp. (f) |
| Gray mold | Botrytis cinerea (f) |
| Soft rot | Rhizopus stolonifer (f) |
| Sour rot | Geotrichum candidum (f) |
| Bacterial soft rot | Erwinia spp. (b) or |
| | Pseudomonas spp. (b) |
| Ripe rot | Colletotrichum sp. (b) |
| Vegetables in general | |
| Watery soft rot | Sclerotinia sp. (f) |
| Cottony leak | Pythium butleri (f) |
| Fusarium rot | Fusarium sp. (f) |
| Bacterial soft rot | Erwinia sp. (b) or |
| | Pseudomonas spp. (b) |

*f = fungus, b = bacterium

Post harvest diseases and/or spoilage can be caused by, for example, fungi and/or bacteria, although generally, fungi are more common than bacteria in most fruits and vegetables. Generally, post harvest diseases and/or spoilage caused by bacteria are rare in fruits and berries but somewhat more common in vegetables.

Most post harvest fungal diseases (rots) are caused by the dispersion of tiny spores formed by the actively growing pathogen. Spores can remain dormant for long periods until the correct conditions for their germination and/or growth occur. These conditions can include the presence of water (in liquid form and/or as high relative humidity), warm temperatures, low light levels, adequate levels of oxygen and/or carbon dioxide, and/or the presence of nutrients, such as in the form of sugars, starches, and/or other organic compounds. Many immature fruits and vegetables contain compounds that inhibit the growth of some disease and/or spoilage organisms. These compounds and the resistance they can provide often are lost during ripening. Therefore, a fresh wound on the surface of a warm, wet, ripened fruit and/or vegetable enclosed within a shipping container can provide an ideal site for post harvest pathogens to colonize and/or develop.

Chlorine dioxide in either a gas and/or solution form can penetrate the cell wall, membrane, and/or cytoplasm of mold spores, bacteria, and/or other microbiological contaminants, such as the disease species that are listed in Table 6, often at concentrations below one part per million, and/or can inhibit their growth and/or destroy them.

Via certain exemplary embodiments, chlorine dioxide can provide certain performance benefits, such as:
chlorine dioxide does not tend to have pH limitations within the range of pHs suitable for the herein described applications;
chlorine dioxide's disinfectant (sterilization) capabilities can be minimally diminished in the presence of soils and/or organics; in this regard chlorine dioxide does not generate THMs, and exhibits minimal capability to generate other chlorinated organics or other harmful by-products through reaction with organics;
chlorine dioxide is strongly soluble in water, and therefore can have a long-lasting residence time, which can reduce the potential for cross-infection and/or re-contamination of the crop and/or process water;
chlorine dioxide can be effective across a broad spectrum, can be a fast acting disinfectant, effective against a wide range of parasites, bacteria, spores, fungi, and/or viruses at relatively low concentrations and/or short contact periods;
at use concentrations suitable for crop washing, chlorine dioxide can be essentially colorless, have a mild medicinal odor, have low corrosivity to metals, and/or have a low acute toxicity rating from the EPA;
at use concentrations suitable for crop washing, chlorine dioxide need not add appreciable taste taint and/or odor to the produce; and/or
the concentration of chlorine dioxide in solution easily can be monitored with commercially available test kits.

Certain exemplary embodiments can provide a method of treating a crop after harvesting (i.e., a “post-harvest crop” and/or a “harvested crop”) without necessarily generating unwanted by-products and/or contaminates that could negatively impact food safety and/or the environment.

Certain exemplary embodiments can provide one or more treatments that can be conducted in a manner that minimizes the re-distribution and/or transmission of pathogens and/or spoilage organisms from soil adhering to the crop, infested crop surfaces, and/or debris, to non-infested surfaces such as harvest and/or trimming cuts, breaks in the skin of the crop through injuries, and/or natural plant surface openings, etc. Certain exemplary embodiments can provide an option to treat, where appropriate, the feed and/or recycled water used in the disinfection process for post-harvest handling and/or treatment. Certain exemplary embodiments can comprise aqueously diluting a molecular matrix-residing chlorine dioxide composition, where the stabilization of the chlorine dioxide has been achieved by compounding it with one or more ingredients that can be food safe and/or environmentally compatible, and/or introducing the resulting chlorine dioxide solution into the treatment solution in an amount effective to achieve substantial reduction and/or elimination of pathogens and/or spoilage organisms, etc. and/or to improve overall shelf life of the crop.

Certain exemplary embodiments can provide a method of utilizing new food safe physical forms of ready-made chlorine dioxide that are now available, which can improve the practicality of using chlorine dioxide in this field.

Certain exemplary embodiments can provide a method of utilizing new food safe physical forms of ready-made chlorine dioxide that are now available, which can improve the practicality of using chlorine dioxide in this field of use.

A gel form of a molecular matrix-residing chlorine dioxide composition is described in U.S. Pat. No. 7,229,647, and for purposes of the present application, the stabilization of the active ingredient can be achieved by compounding with food safe ingredient(s) that are also environmentally acceptable, such as those that meet applicable EPA standards. The available chlorine dioxide concentration can be in the range of approximately 0 ppm up to approximately 3000-4000 ppm, up to approximately 6000 ppm if storage temperatures are maintained below approximately 80 F, and greater than 6000 ppm if refrigerated storage is provided. The stabilization ingredient for this composition can be a high molecular weight polymer of acrylic acid that is cross linked, such as Cabopol 5984, which is manufactured by Lubrizol Advanced Materials, Inc. A solid form of a molecular matrix-residing chlorine dioxide composition is described in US Patent Application Publication 2009/0054375, and can have an available chlorine dioxide concentration of up to 65,000 ppm (6.5% by weight). The stabilization of the active ingredient can be achieved by compounding with ingredients that are food safe and/or environmentally acceptable, that is, meet applicable EPA regulations. These specific examples are not intended to limit or preclude the use of other compatible “food safe” and/or environmentally acceptable molecular matrix-residing chlorine dioxide composition formulations and/or forms that can be used advantageously as described herein.

The above are examples of dilutable “molecular matrix-residing chlorine dioxide composition”, where the stabilization of the chlorine dioxide is achieved by compounding with one or more food safe ingredients. The inclusion of these specific examples is not intended to limit or preclude the use of other crop compatible food safe and/or environmentally appropriate molecular matrix-residing chlorine dioxide composition formulations and/or forms.

The solid and/or the gel molecular matrix-residing chlorine dioxide composition formulations can be suitable for packaging in water soluble pouch formats, based on, for example, SOLUBLON® PVA films (supplied by Aicello Chemical Co., Ltd). Such formats can allow precise unit dosing for batch production. These films have been granted “tolerance exemptions” by the US EPA. This approach can enhance the already positive environmental and/or human safety profile of certain exemplary embodiments by eliminating the need to manage secondary container disposal.

Any of the chlorine dioxide concentrate forms can be dissolved and/or dispersed in water to attain an initial chlorine dioxide solution of a desired concentration. This solution can be applied as a liquid and/or vapor. Desired chlorine dioxide concentrations can range from about 5 ppm, which can be suitable for treating crops, to from about 100 ppm to about 1000 ppm, which can be suitable for disinfecting processing and/or handling equipment and/or facility surfaces, such as harvest bins, palletized totes, and/or pallet skids. The dissolving/dispersing of the chlorine dioxide concentrate can be performed just before application, or at some time well prior to the application, consistent with correct storage conditions of the diluted solution that will maintain an efficacious concentration of chlorine dioxide. Best storage conditions can include containment in tightly closed vessels, protected from light, and/or avoiding excessive temperatures. The chlorine dioxide solution can contain other beneficial components, such as surfactants and/or other components to enhance soil removal and/or wetting of surfaces to be cleaned/sanitized, or wax coating formulations and/or other leave-on treatments, consistent with compatibility of these components with chlorine dioxide. The beneficial components can be added to the chlorine dioxide solution, incorporated into the dilution water before the dissolving the chlorine dioxide concentrate, and/or incorporated into the chlorine dioxide concentrate forms before dilution.

The initial chlorine dioxide solution can be applied to: flumes, water dump tanks, drench tanks, spray washers, hydrocoolers, and/or water for grading operations. Where any of these waters is sourced from surface water sources, pre-treatment with the ClO2 solution to kill existing microorganisms might be necessary. ClO2 can be an outstanding choice for treating such surface waters due to its efficacy against, for example, pathogens in surface water of concern to human safety (i.e. Cryptosporidium, Giardia).

The chlorine dioxide solution can be applied to: seeds, cuttings/slips, cutting implements, spray tank, harvest totes, butt spray (celery and lettuce), head spray (cauliflower), worker glove and boot dips, calcium infusion treatment water, peelers, and/or packing lines, etc.

The shelf life of freshly-cut flowers can be extended by brief dipping of the cut stem end and/or extended immersion of the cut stem end in the chlorine dioxide solution. The benefits of cut stem end dipping and immersion have been reported in Special Research Report #448: Postproduction Chlorine Dioxide Reduces Bacteria and Increases Vase Life of Fresh Cut Flowers by A. J. Macnish, Postdoctoral Researcher, T. A. Nell, Professor and Chairman, R. T. Leonard, Biological Scientist, and A. M. Alexander, Biological Scientist Department of Environmental Horticulture, University of Florida, Gainesville, 32611.

It can be possible to reduce or eliminate the re-distribution and/or transmission of pathogens and/or spoilage organisms, fungi, etc., on a harvested crop and/or processing and/or handling equipment by treating them with a fine mist, fog, and/or spray of a solution of a molecular matrix-residing chlorine dioxide composition. The appropriate apparatus to form such a fine mist and/or fog and/or spray from such a solution are known to those skilled in the art. Such a treatment can have an advantage over treatment with a bulk solution where it is undesirable to get the crop grossly wet. Such a treatment can have the advantage over treatment with a coarser spray where the coarser spray might not access finer recesses of the crop.

It can be desirable to treat a crop with chlorine dioxide vapor (gas-phase chlorine dioxide) for the same objectives, i.e., to reduce, minimize, and/or eliminate the re-distribution and/or transmission of pathogens and/or spoilage organisms, fungi, etc., from soil that adheres to any of the harvested crop items, any infested surface of any of the harvested crop items, and/or equipment used to process and/or handle the harvested crop items. Gas-phase chlorine dioxide can be obtained from the molecular matrix-residing chlorine dioxide composition formulations by any of several methods or a combination of them. These methods can include: 1) exposure of the molecular matrix-residing chlorine dioxide composition to the air in a closed or partially closed container; 2) applying heat to the molecular matrix-residing chlorine dioxide composition inside the container; 3) bubbling a gas through a solution of the molecular matrix-residing chlorine dioxide composition, the gas released through an effervescent process and/or a compressed or pumped gas such as air, nitrogen, etc.; 4) in the case of the solid described above, that solid can be mixed with a hygroscopic and/or deliquescent salt before or during exposure to the air in the container to accelerate the release of chlorine dioxide directly into the gas phase (described in USPTO Application 61/383,446). The gas-phase chlorine dioxide can be thus obtained either directly inside the container holding the crop, or outside said container then pumped or otherwise transmitted into the crop container.

In certain exemplary embodiments, the molecular matrix-residing chlorine dioxide composition can comprise actual chlorine dioxide rather than precursor chemicals. The chlorine dioxide in the solutions prepared from these concentrates can be immediately available, and/or relatively little to no waiting time need be required for the chlorine dioxide to become available. In certain exemplary embodiments, the chlorine dioxide concentrate can be comprised of highly pure chlorine dioxide that has been stabilized via compounding with food safe ingredients. Thus, there need be no human health risk in the unlikely event that a residue is left on the crop due to non-ideal post-harvest processing etc.

Via certain exemplary embodiments, the chlorine dioxide immediately can be available by the simple dilution of the molecular matrix-residing chlorine dioxide composition with water, down to the target concentration for the desired chlorine dioxide treatment. Utilizing a molecular matrix-residing chlorine dioxide composition having up to 65,000 ppm chlorine dioxide available can allow significantly large volumes of treatment water to be made available on demand.

Certain exemplary embodiments can provide a composition of molecular matrix-residing chlorine dioxide where the stabilization of the active ingredient has been achieved by compounding with certain ingredients, potentially including food safe ingredients that are potentially also environmentally acceptable. Certain exemplary embodiments can provide for introducing the resulting chlorine dioxide gas that is released by this composition upon the removal and/or puncturing of the outer protective layer of the packaging format containing the composition. Certain exemplary embodiments can provide an amount of chlorine dioxide that is sufficient to achieve elimination and/or inhibition of bacteria, fungi, and/or molds on fruits and/or vegetables and/or improve overall shelf life of the same.

Certain exemplary embodiments can provide a method of utilizing new physical forms of ready-made chlorine dioxide that are now available, which can improve the practicality of using chlorine dioxide in this field of use.

A gel form of a molecular matrix-residing chlorine dioxide is described in U.S. Pat. No. 7,229,647, and for purposes of the present application, the stabilization of the active ingredient can be achieved by compounding with food safe ingredient(s) that are also environmentally acceptable. The available chlorine dioxide concentration can be in the range of approximately 0 ppm up to approximately 3000-4000 ppm, up to approximately 6000 ppm if storage temperatures are maintained below approximately 80 F, and greater than 6000 ppm if refrigerated storage is provided. The stabilization ingredient for this composition can be a high molecular weight polymer of acrylic acid that is cross linked, such as Cabopol 5984, which is manufactured by Lubrizol Advanced Materials, Inc. A solid form of a molecular matrix-residing chlorine dioxide is described in US Patent Application Publication 2009/0054375, and can have an available chlorine dioxide concentration of up to 65,000 ppm (6.5% by weight). The stabilization of the active ingredient can be achieved by compounding with ingredients that are food safe and/or environmentally acceptable, that is, meet applicable EPA regulations. These specific examples are not intended to limit or preclude the use of other compatible “food safe” and/or environmentally acceptable molecular matrix-residing chlorine dioxide formulations and/or forms that can be used advantageously as described herein.

Moisture can be attracted from the air by hygroscopic agents and/or desiccants. Examples of hygroscopic substances that are food safe can include sugar, glycerol, and/or honey, etc. One particular applicable class of hygroscopic agents is deliquescent salts. Examples of deliquescent salts that can meet the food safe criteria are potassium phosphate, calcium chloride, and/or magnesium chloride, etc. Examples of deliquescent salts that might be non-food-safe are lithium chloride, lithium bromide, lithium iodide, etc.

### Example 11

This Example uses calcium chloride (CaCl2) as the deliquescent salt. Three blends of the solid form of a molecular matrix-residing chlorine dioxide (a chlorine dioxide/a-cyclodextrin complex) mixed with essentially anhydrous CaCl2 (each previously finely ground) were prepared at different ratios and enclosed in porous pouches made from an essentially inert non-woven fabric. The pouches were stored in individual glass jars to protect them from moisture until the beginning of the test. Each pouch contained 1.0 g of the complex, plus the proportionate amount of CaCl2. The weight ratios were:
a) 1:1 complex:CaCl2,
b) 10:1 complex:CaCl2, and
c) complex alone (control).

A closed glass 12 L round-bottom flask was used as the test air chamber. The humidity of the chamber was set by adding about 3 g of a saturated solution of an appropriate salt to a piece of filter paper inside the flask. It is known that saturated salt solutions will equilibrate with the air in contact with them, to attain a specific relative humidity (RH) determined by the salt, with a mild dependence on temperature. To fix the relative humidity at about 75.5%, a saturated sodium chloride solution was used. To separately fix the RH at about 85.1%, a saturated potassium chloride solution was used.

At the commencement of each test, once the relative humidity had stabilized, as determined through measurement with a hygrometer, a pouch was removed from its jar and suspended by string inside the chamber. Measurements of the ClO2 concentration in the air of the chamber were taken at timed intervals, using a GasAlert Extreme Single Gas ClO2 monitor (from BW Technologies by Honeywell) for concentrations from 0.03 ppm up to 1.00 ppm, and a UV/visible spectrophotometer (from StellarNet Inc.) for concentrations greater than about 67 ppm.

Results are shown in Table 7. After 1 minute, the maximum concentration of ClO2 in the air was produced by the 10:1 ratio of complex to CaCl2, at both humidities. The 1:1 ratio actually produced a lower concentration than the control at both humidities at this short time interval.

The highest ClO2 concentrations, attained after roughly 24 hours, followed generally the same pattern, i.e., levels at 85% RH were greater than at 75% RH where quantitative values were available, and the 10:1 ratio produced the highest concentrations. However, the concentration produced by the 1:1 ratio had exceeded the control, at both humidities, by this time period.

TABLE 7

| Ratio | Headspace ClO2 concentra- | | Maximum headspace ClO2 | |
|---|---|---|---|---|
| complex: | tion (ppm) after 1 minute | | concentration (ppm) | |
| CaCl2 | 75.5% RH | 85.1% RH | 75.5% RH | 85.1% RH |
| 10:1 | >1 | 0.54 | 700 | 800 |
| 1:1 | 0.17 | 0.31 | 100 | 135 |
| Control | 0.32 | 0.34 | BL | BL |
| (no CaCl2) | | | | |

BL = below lower detection limit, approximately 67 ppm, of the UV/visible system

### Example 12

The solid form of a molecular matrix-residing chlorine dioxide was enclosed in 4 separate porous pouches made from an essentially inert non-woven fabric. Two of the pouches contained 0.25 g of the complex and the other two contained 0.5 g of the complex. The chlorine dioxide concentration of the complex was 6.3% by wt. The pouches were stored in individual glass jars to protect them from moisture until the start of the test.

A closed glass 12L round-bottom flask was used as the test air chamber and about 3 g of a saturated solution of an appropriate salt was added to a piece of filter paper to control the humidity as in example 11. To fix the relative humidity at about 75.5%, a saturated solution of sodium chloride was used. To separately fix the RH at about 85.1%, a saturated potassium chloride solution was used.

Once the relative humidity had stabilized inside the test chamber, as determined through measurement with a hygrometer, each test was begun by removing a pouch from its jar and suspending it by string inside the chamber. Measurements of the ClO2 concentration in the air of the chamber were taken at timed intervals, using the Kitagawa chlorine dioxide gas detector tube system.

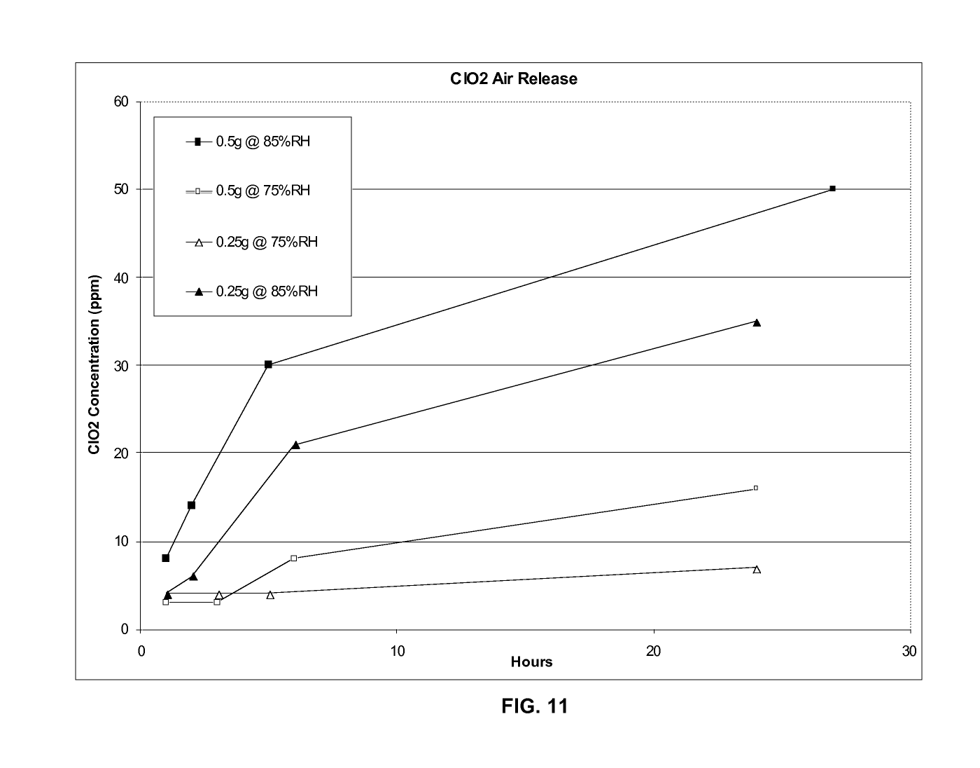

Results are shown in FIG. 11. The relative humidity level that each pouch was exposed to had a significant effect on the amount of ClO2 released, as seen by the higher concentrations of ClO2 released by both the 0.5 g and 0.25 g pouches at 85% RH. The 0.5 g pouches released higher amounts of ClO2 compared to the 0.25 g pouches when comparing each at both of the relative humidity levels used.

Certain exemplary embodiments can provide storage stability protection prior to use, to the complex and/or the complex in conjunction with hygroscopic agents, etc. Certain exemplary embodiments can allow easy initiation by removal of the moisture barrier just prior to use, which then can permit the free passage of chlorine dioxide into the processing water and/or processing water into the porous pouch. Certain exemplary embodiments can reduce and/or minimize any potential direct contact of the composition with the fruit and/or vegetables being processed.

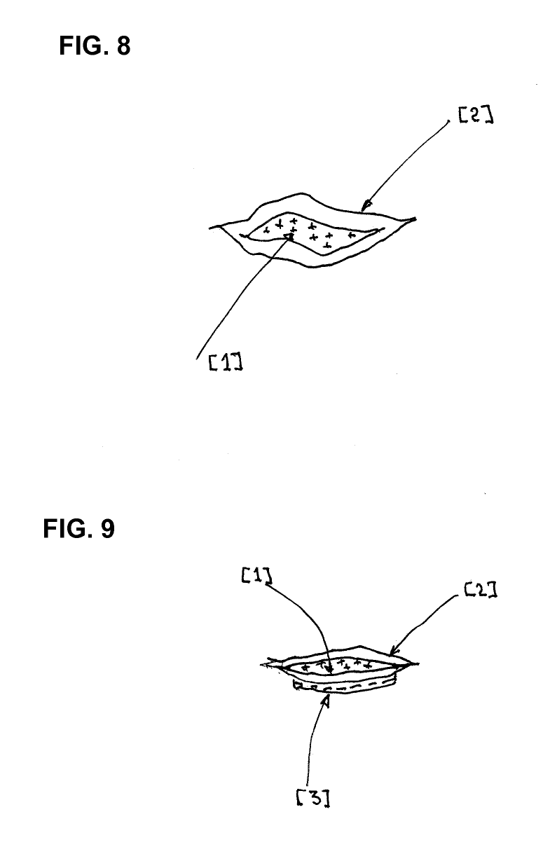

FIG. 8 is a schematic that illustrates an exemplary packaging format/delivery system 8000 that can be used with certain processes. A sachet (1) can contain the complex and/or a combination of the complex and one or more hygroscopic agent(s). The sachet can be made from a non-porous material and/or a porous material such as heat sealable non woven permeable fabric having a pore size greater than 1 micron. An example of such a commercially available material is DuPont Flashspun HDPE 1059B, which can contain a wetting agent. The protective outer packaging material (2) can be a moisture barrier laminate that is heat sealable. An example of such a commercial available material is 3M Dri-Shield 2000.

FIG. 9 is a schematic that illustrates an exemplary packaging format/delivery system 9000 that can be used with certain processes. This embodiment can be a scaled down version of the exemplary embodiment illustrated in FIG. 8, potentially with the addition of a pressure sensitive adhesive layer (3) that can allow this packaging format to adhere to the inside of the clam shell (e.g., bottom or lid) prior to filling with product, such that the package can be activated at any time thereafter. For example, if the purchaser of fruit in such a clam shell wishes to store the fruit in the clam shell, they can activate the package after purchase to improve storage characteristics of the fruit.

The exemplary packaging format illustrated in FIG. 8 can be used in those categories of fruits and/or vegetables that typically use large shipping cases, such as citrus crops, where the outer protective packaging layer of the packaging format can be removed to initiate chlorine dioxide release from the molecular matrix-residing chlorine dioxide composition at the time of processing the fruit and/or vegetables for shipment.

In the case of the packaging format illustrated in FIG. 9, the protective layer of packaging can be punctured in multiple places, via for example, a pinwheel perforator and/or similar device, just prior to the addition of the crop to the container.

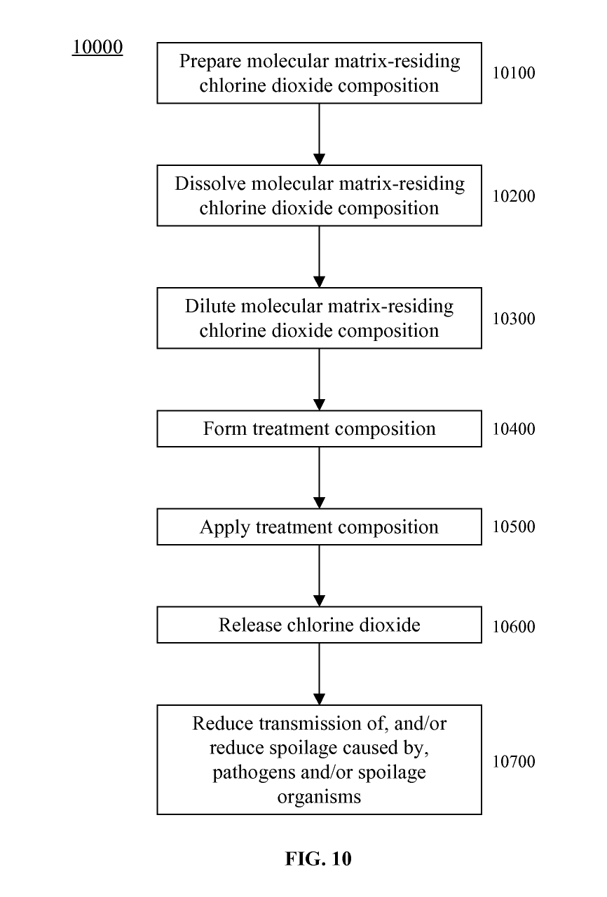

FIG. 10 is a flowchart of an exemplary embodiment of a method 10000. At activity 10100, the molecular matrix-residing chlorine dioxide composition can be prepared. At activity 10200, the molecular matrix-residing chlorine dioxide composition can be dissolved. At activity 10300, molecular matrix-residing chlorine dioxide composition and/or a solution containing it can be diluted. At activity 10400, the treatment composition can be formed from the molecular matrix-residing chlorine dioxide composition and/or a solution containing it. At activity 10500, the treatment composition can be applied to a predetermined target, such as a target associated with a plurality of harvest crop items. At activity 10600, chlorine dioxide can be released and/or applied to the target. At activity 10700, via application of the treatment composition and/or release of chlorine dioxide therefrom, concentration of, transmission of, and/or spoilage caused by, pathogens and/or spoilage organisms associated with the predetermined target and/or the plurality of harvested crop items can be reduced.

Certain exemplary embodiments can provide a system, machine, device, manufacture, circuit, composition of matter, and/or user interface adapted for and/or resulting from, and/or a method and/or machine-readable medium comprising machine-implementable instructions for, activities that can comprise and/or relate to:
applying a treatment composition to a predetermined target, the treatment composition comprising or derived from a molecular matrix-residing chlorine dioxide composition;
diluting the molecular matrix-residing chlorine dioxide composition;
dissolving the molecular matrix-residing chlorine dioxide composition; forming the treatment composition; and/or
releasing a chlorine dioxide vapor from the molecular matrix-residing chlorine dioxide composition;

wherein:
application of the treatment composition is sufficient to reduce transmission of, and/or reduce spoilage of the plurality of harvested crop items caused by, pathogens and/or spoilage organisms associated with the predetermined target;
the molecular matrix-residing chlorine dioxide composition comprises one or more food safe and/or environmentally acceptable components;
the predetermined target is associated with a plurality of harvested crop items;
the molecular matrix-residing chlorine dioxide composition is supplied in a water-soluble package;
the molecular matrix-residing chlorine dioxide composition is supplied in a unit dose water-soluble package comprising one or more food-safe components;
the treatment composition comprises one or more surfactants;
the treatment composition comprises one or more components adapted to enhance soil removal;
the treatment composition comprises one or more components adapted to enhance wetting of surfaces;
the treatment composition comprises one or more wax coating formulations;
the treatment composition comprises an insecticide;
the treatment composition comprises a chlorine dioxide vapor;
the predetermined target is water that contacts the plurality of harvested crop items;
the predetermined target is water that transports the plurality of harvested crop items;
the predetermined target is water used for processing the plurality of harvested crop items;
the predetermined target is water that cools the plurality of harvested crop items;
the predetermined target is an exterior surface of each of the plurality of harvested crop items;
the predetermined target is soil adhering to an exterior surface of a harvested crop item from the plurality of harvested crop items; and/or
the predetermined target is one or more surfaces of equipment used to process and/or handle the plurality of harvested crop items.

### DEFINITIONS

When the following phrases are used substantively herein, the accompanying definitions apply. These phrases and definitions are presented without prejudice, and, consistent with the application, the right to redefine these phrases via amendment during the prosecution of this application or any application claiming priority hereto is reserved. For the purpose of interpreting a claim of any patent that claims priority hereto, each definition in that patent functions as a clear and unambiguous disavowal of the subject matter outside of that definition.
a—at least one.
activity—an action, act, step, and/or process or portion thereof.
adapted to—suitable, fit, and/or capable of performing a specified function.
adhere—to contact, touch, cohere, cling, and/or stick.
amount—a quantity.
and/or—either in conjunction with or in alternative to.
apparatus—an appliance or device for a particular purpose
application—using something for a particular purpose.
apply—to put to use for a purpose.
associate—to join, connect together, and/or relate.
associated with—related to and/or accompanying.
at—in, on, and/or near.
bacterial—relating to one or more bacteria.
barrier—a structure that impedes and/or obstructs free movement.
by—via and/or with the use or help of.
can—is capable of, in at least some embodiments.
cause—to bring about, provoke, precipitate, produce, elicit, be the reason for, result in, and/or effect.
chlorine dioxide—a highly reactive oxide of chlorine with the formula ClO₂ or ClO2, it can appear as a reddish-yellow gas that crystallizes as orange crystals at −59° C., and it is a potent and useful oxidizing agent often used in water treatment and/or bleaching.
circuit—an electrically conductive pathway and/or a communications connection established across two or more switching devices comprised by a network and between corresponding end systems connected to, but not comprised by the network.
coating—an initially fluent film or layer of material lying on or bonded to the surface of a base and/or an impregnating material that penetrates the base either partially or completely and all or part of which is retained therein, either in its original form or physically or chemically combined therewith.
complex—an association of compositions, substances, elements, molecules, atoms, and/or ions.
component—a constituent element and/or part.
composition—a composition of matter and/or an aggregate, mixture, reaction product, and/or result of combining two or more substances.
comprising—including but not limited to.
configure—to make suitable or fit for a specific use or situation.
contact—to touch, adhere, cohere, cling, and/or stick.
contain—to restrain, hold, store, and/or keep within limits.
container—something that at least partially, holds, carries, and/or encloses one or more items for transport, storage, and/or protection, etc.
containing—including but not limited to.
convert—to transform, adapt, and/or change.
cool—to make less warm, to remove heat from, and/or to reduce the molecular and/or kinetic energy of
create—to bring into being.
crop—commercially desirable plants, including but not limited to those used in total or in part for food and/or agriculture (including vegetables, fruits, berries, produce, grains, grasses, nuts, herbs, spices, tobacco, etc.), fibers (e.g., cotton, linen, soy, hemp, ramie, bamboo, kenaf, etc.), construction and/or other structural applications (e.g., timber, lumber, veneer, particleboard, erosion control, etc.), and/or aesthetic, decorative, and/or ornamental purposes (such as flowers, trees, shrubs, and/or turf, etc.), etc.
cyclodextrin—any of a group of cyclic oligosaccharides, composed of 5 or more α-D-glucopyranoside units linked 1→4, as in amylose (a fragment of starch), typically obtained by the enzymatic hydrolysis and/or conversion of starch, designated α-, β-, and γ-cyclodextrins (sometimes called cycloamyloses), and used as complexing agents and in the study of enzyme action. The 5-membered macrocycle is not natural. Recently, the largest well-characterized cyclodextrin contains 32 1,4-anhydroglucopyranoside units, while as a poorly characterized mixture, even at least 150-membered cyclic oligosaccharides are also known. Typical cyclodextrins contain a number of glucose monomers ranging from six to eight units in a ring, creating a cone shape, typically denoted as: α-cyclodextrin: six-membered sugar ring molecule; β-cyclodextrin: seven sugar ring molecule; and γ-cyclodextrin: eight sugar ring molecule.
define—to establish the outline, form, and/or structure of.
deliquescent—to dissolve and become liquid by absorbing moisture from the air.
deliver—to provide, set free, release, distribute, and/or convey
derive—to obtain from a source.
determine—to find out, obtain, calculate, decide, deduce, ascertain, and/or come to a decision, typically by investigation, reasoning, and/or calculation.
device—a machine, manufacture, and/or collection thereof.
dilute—to make thinner and/or less concentrated by adding a liquid such as water.
directly—without anything in between and/or intervening.
dissolve—to make a solution of, as by mixing with a liquid and/or to pass into solution.
each—every one of a group considered individually.
edible—An object that is fit for consumption by an human and/or animal by chewing and/or masticating prior to swallowing.
effective—sufficient to bring about, provoke, elicit, and/or cause.
enclose—to surround, contain, and/or hold.
enhance—to improve or make better.
environmentally acceptable—compliant and/or not outside standards and/or guidelines set by the Environmental Protection Agency of the United States of America or a functionally similar organization associated with another jurisdiction.
equipment—one or more machines, apparatuses, and/or devices.
estimate—(n) a calculated value approximating an actual value; (v) to calculate and/or determine approximately and/or tentatively.
exterior—a region that is outside of a device and/or system.
fabric—a material formed by weaving, knitting, pressing, and/or felting natural or synthetic fibers.
film—a thin covering and/or coating
food—a man-made and/or naturally-occurring discrete article consumable by animals and/or humans for nourishment.
food grade—determined by the US Food and Drug Administration as safe for use in food.
food safe—any ingredient(s) that are found/listed and defined in the US Food and Drug Administration categories of Food Additive, Food Contact Substance, Generally Recognized As Safe, Indirect Food Additive, Secondary and/or Direct Food Additive. A food additive is defined in Section 201(s) of the FD&C Act as any substance the intended use of which results or may reasonably be expected to result, directly or indirectly, in its becoming a component or otherwise affecting the characteristic of any food (including any substance intended for use in producing, manufacturing, packing, processing, preparing, treating, packaging, transporting, or holding food). Section 409 of the FD&C Act defines a Food Contact Substance (“FCS”) as any substance that is intended for use as a component of materials used in manufacturing, packing, packaging, transporting, or holding food if such use of the substance is not intended to have any technical effect in such food. Additional information can be found on the Food Contact Substances Notification Program page. Under sections 201(s) and 409 of the FD&C Act, any substance that is intentionally added to food is a food additive, that is subject to pre-market review and approval by FDA, unless the substance is generally recognized, among qualified experts, as having been adequately shown to be safe under the conditions of its intended use, or unless the use of the substance is otherwise excluded from the definition of a food additive. Generally Recognized As Safe (“GRAS”) substances are distinguished from food additives by the type of information that supports the GRAS determination, that it is publicly available and generally accepted by the scientific community, but should be the same quantity and quality of information that would support the safety of a food additive. Additional information on GRAS can be found on the GRAS Notification Program page. In general, Indirect Food Additives are food additives that come into contact with food as part of packaging, holding, or processing, but are not intended to be added directly to, become a component, or have a technical effect in or on the food. Indirect Food Additives mentioned in Title 21 of the U.S. Code of Federal Regulations (can be used in food-contact articles. The term Secondary Direct Food Additive is found in 21 CFR section 173, which was created during re-codification of the food additive regulations in 1977. A Secondary Direct Food Additive has a technical effect in food during processing but not present in the finished food (e.g., processing aids).
form—to construct.
formulation—a composition.
from—used to indicate a source, origin, and/or location thereof.
fungal—relating to one or more fungi.
further—in addition.
gel—a solid, semisolid, and/or liquid colloid system formed of a continuous and/or semicontinuous solid phase and a liquid phase (either discontinuous or continuous or mixed). In its sufficiently viscous forms, i.e., comprising a sufficiently high concentration of the colloid component, it is often identified by its outward gelatinous appearance, exhibiting properties of a solid such as plasticity, elasticity, or rigidity, such as little or no tendency to easily flow. Gels of the solid or semisolid variety are typically characterized by a physical property of the system, such as the yield point (defined as the shearing force required to result in the flow of said gel), which is a measure of the gel strength. A variety of compositions can form gels, including but not limited to: solubilized polymers, cross-linked polymers, concentrated surfactant solutions having crystalline-like properties (e.g., liquid crystal phases), organically modified and unmodified hydrous metal oxides (e.g., silica, silicates, alumina, iron, etc.), and organically modified and unmodified hydrous mixed metal oxides (e.g., clays, bentonites, synthetic aluminosilicates), etc.
generate—to create, produce, give rise to, and/or bring into existence.
greater than—larger and/or more than.
growth—an increase in the number of cells comprised by a living entity.
handle—to touch, manipulate, and/or deal with.
harvest—(v) to gather a crop; (n) the act, process, and/or result of gathering a crop.
having—including but not limited to.
headspace—a substantially unoccupied and/or empty volume left at the top and/or end of an almost filled container.
heat—(n.) energy associated with the motion of atoms or molecules and capable of being transmitted through solid and fluid media by conduction, through fluid media by convection, and through an empty space and/or fluid by radiation; (v.) to transfer energy from one substance to another resulting in an increase in temperature of one substance.
hold—to store, contain, retain, and/or support.
hygroscopic—capable of readily absorbing moisture, such as from the atmosphere and/or ambient environment.
including—including but not limited to.
inhibit—to prevent, resist, prohibit, and/or forbid.
initialize—to prepare something for use and/or some future event.
insecticide—a composition used to kill insects.
item—a single article of a plurality of articles.
material—a substance and/or composition.
may—is allowed and/or permitted to, in at least some embodiments.
method—one or more acts that are performed upon subject matter to be transformed to a different state or thing and/or are tied to a particular apparatus, said one or more acts not a fundamental principal and not pre-empting all uses of a fundamental principal.
micron—a unit of length equal to one millionth of a meter.
moisture—diffuse wetness that can be felt as vapor in the atmosphere and/or condensed liquid on the surfaces of objects.
molecular matrix-residing chlorine dioxide—a gel and/or solid material that comprises chlorine dioxide, is essentially free of chloride, chlorite, and chlorate ions, and retains at least 90% (by weight) of an initial amount of the chlorine dioxide for at least 80 days when stored at or below 5 degrees C.
more—a quantifier meaning greater in size, amount, extent, and/or degree.
non—not.
occur—to take place.
one—being or amounting to a single unit, individual, and/or entire thing, item, and/or object.
organism—an individual form of life, such as a plant, animal, bacterium, protist, and/or fungus; and/or a body made up of organs, organelles, or other parts that work together to carry on the various processes of life.
outer—farther than another from the center and/or middle.
package—a container in which something is packed, encased, encompassed, and/or surrounded for storage and/or transportation.
package—a container.
pathogen—an agent that causes infection and/or disease, especially a microorganism, such as a bacterium or protozoan, or a virus.
permeable—the property of allowing passage or migration of other material through a barrier or septum of the material so designated. The migration phenomenon is due primarily to the chemical nature of the materials involved and may include molecular weight or size as a factor.
pharmaceutical grade—determined by the US Food and Drug Administration as safe for use in drugs.
plurality—the state of being plural and/or more than one.
pore—a tiny opening through which certain fluids may pass. Generally, the pore opening is of such irregular direction that light will not pass through it.
post-harvest—after being harvested.
predetermined—established in advance.
prior—before and/or preceding in time and/or order.
probability—a quantitative representation of a likelihood of an occurrence.
process—(n.) a procedure and/or organized series of actions, changes, and/or functions adapted to bring about a result; (v.) to put through the steps of a predetermined procedure.
project—to calculate, estimate, or predict.
protect—to guard, defend, and/or keep from being damaged, attacked, stolen, and/or injured.
protective—something that protects and/or is adept at protecting.
provide—to furnish, supply, give, and/or make available.
range—a measure of an extent of a set of values and/or an amount and/or extent of variation.
ratio—a relationship between two quantities expressed as a quotient of one divided by the other.
receive—to get as a signal, take, acquire, and/or obtain.
recommend—to suggest, praise, commend, and/or endorse.
reduce—to make and/or become lesser and/or smaller and/or to cause a diminishment in magnitude.
release—to let go and/or free from something that restrains, binds, fastens, and/or holds back.
removal—to be moved from a place and/or position occupied and/or the act of removing.
repeatedly—again and again; repetitively.
request—to express a desire for and/or ask for.
retain—to restrain, keep, and/or hold.
safe—relatively free from risk and/or danger.
salt—a chemical compound formed by replacing all or part of the hydrogen ions of an acid with metal ions and/or electropositive radicals.
seal—to shut close; to keep close; to make fast; to keep secure; to prevent leakage.
select—to make a choice or selection from alternatives.
set—a related plurality.
size—physical dimensions, proportions, magnitude, amount, and/or extent of an entity.
soil—the top layer of the earth's surface, consisting of rock and mineral particles mixed with organic matter.
solid—neither liquid nor gaseous, but instead of definite shape and/or form.
soluble—capable of being dissolved and/or liquefied.
solution—a substantially homogeneous molecular mixture and/or combination of two or more substances.
spoilage—a process, act, and/or instance of becoming spoiled and/or a condition of being spoiled.
store—to place, hold, and/or retain data, typically in a memory.
substantially—to a great extent and/or degree.
sufficient—a degree and/or amount necessary to achieve a predetermined result.
supply—make available for use.
surface—any face and/or outer boundary of a body, object, and/or thing.
surfactant—a surface-active substance, such as a substance that, when dissolved in water, lowers the surface tension of the water and increases the solubility of organic compounds.
surround—to encircle, enclose, and/or confine on several and/or all sides.
system—a collection of mechanisms, devices, machines, articles of manufacture, processes, data, and/or instructions, the collection designed to perform one or more specific functions.
target—a thing at which an action is directed.
technical grade—containing small amounts of other chemicals, hence slightly impure.
that—a pronoun used to indicate a thing as indicated, mentioned before, present, and/or well known.
transform—to change in measurable: form, appearance, nature, and/or character.
transmission—a conveyance of material from one location to another.
transport—to move, convey, and/or carry from one place to another.
treatment—an act, manner, or method of handling or dealing with someone or something.
unit dose package—a single dose in a container.
used—employed in accomplishing something.
vapor—a gaseous form of a fluid.
via—by way of and/or utilizing.
water—a transparent, odorless, tasteless liquid containing approximately 11.188 percent hydrogen and approximately 88.812 percent oxygen, by weight, characterized by the chemical formula H₂O, and, at standard pressure (approximately 14.7 psia), freezing at approximately 32° F. or 0° C. and boiling at approximately 212° F. or 100° C.
wax—any of various natural, oily, and/or greasy heat-sensitive substances, typically comprising hydrocarbons and/or esters of fatty acids that are insoluble in water but soluble in nonpolar organic solvents.
weight—a value indicative of importance.
wet—to dampen, cover, and/or soak with a liquid, such as water.
wherein—in regard to which; and; and/or in addition to.
woven—constructed by interlacing and/or interweaving strips or strands of material.

### Note

Various substantially and specifically practical and useful exemplary embodiments of the claimed subject matter are described herein, textually and/or graphically, including the best mode, if any, known to the inventor(s), for implementing the claimed subject matter by persons having ordinary skill in the art. Any of numerous possible variations (e.g., modifications, augmentations, embellishments, refinements, and/or enhancements, etc.), details (e.g., species, aspects, nuances, and/or elaborations, etc.), and/or equivalents (e.g., substitutions, replacements, combinations, and/or alternatives, etc.) of one or more embodiments described herein might become apparent upon reading this document to a person having ordinary skill in the art, relying upon his/her expertise and/or knowledge of the entirety of the art and without exercising undue experimentation. The inventor(s) expects skilled artisans to implement such variations, details, and/or equivalents as appropriate, and the inventor(s) therefore intends for the claimed subject matter to be practiced other than as specifically described herein. Accordingly, as permitted by law, the claimed subject matter includes and covers all variations, details, and equivalents of that claimed subject matter. Moreover, as permitted by law, every combination of the herein described characteristics, functions, activities, substances, and/or structural elements, and all possible variations, details, and equivalents thereof, is encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language herein should be construed as indicating any non-claimed subject matter as essential to the practice of the claimed subject matter.

Thus, regardless of the content of any portion (e.g., title, field, background, summary, description, abstract, drawing figure, etc.) of this document, unless clearly specified to the contrary, such as via explicit definition, assertion, or argument, or clearly contradicted by context, with respect to any claim, whether of this document and/or any claim of any document claiming priority hereto, and whether originally presented or otherwise:
there is no requirement for the inclusion of any particular described characteristic, function, activity, substance, or structural element, for any particular sequence of activities, for any particular combination of substances, or for any particular interrelationship of elements;
no described characteristic, function, activity, substance, or structural element is “essential”;
any two or more described substances can be mixed, combined, reacted, separated, and/or segregated;
any described characteristics, functions, activities, substances, and/or structural elements can be integrated, segregated, and/or duplicated;
any described activity can be performed manually, semi-automatically, and/or automatically;
any described activity can be repeated, any activity can be performed by multiple entities, and/or any activity can be performed in multiple jurisdictions; and
any described characteristic, function, activity, substance, and/or structural element can be specifically excluded, the sequence of activities can vary, and/or the interrelationship of structural elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context.

The terms “comprising,” “having,” “including,” and “containing” are to be construed as open-ended terms (i.e., meaning “including, but not limited to,”) unless otherwise noted.

When any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any phrase (i.e., one or more words) appearing in a claim is followed by a drawing element number, that drawing element number is exemplary and non-limiting on claim scope.

No claim of this document is intended to invoke paragraph six of 35 USC 112 unless the precise phrase “means for” is followed by a gerund.

Any information in any material (e.g., a United States patent, United States patent application, book, article, etc.) that has been incorporated by reference herein, is incorporated by reference herein in its entirety to its fullest enabling extent permitted by law yet only to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Within this document, and during prosecution of any patent application related hereto, any reference to any claimed subject matter is intended to reference the precise language of the then-pending claimed subject matter at that particular point in time only.

Accordingly, every portion (e.g., title, field, background, summary, description, abstract, drawing figure, etc.) of this document, other than the claims themselves and any provided definitions of the phrases used therein, is to be regarded as illustrative in nature, and not as restrictive. The scope of subject matter protected by any claim of any patent that issues based on this document is defined and limited only by the precise language of that claim (and all legal equivalents thereof) and any provided definition of any phrase used in that claim, as informed by the context of this document.

What is claimed is:

1. A method, comprising:
applying a treatment composition to a predetermined target associated with a plurality of harvested crop items, application of the treatment composition sufficient to reduce transmission of, and/or reduce spoilage of the plurality of harvested crop items caused by, pathogens and/or spoilage organisms associated with the predetermined target, the treatment composition comprising or derived from a molecular matrix-residing chlorine dioxide composition that comprises one or more food safe and/or environmentally acceptable components.

2. The method of claim 1, further comprising:
diluting the molecular matrix-residing chlorine dioxide composition.

3. The method of claim 1, further comprising:
dissolving the molecular matrix-residing chlorine dioxide composition.

4. The method of claim 1, further comprising:
forming the treatment composition.

5. The method of claim 1, further comprising:
releasing a chlorine dioxide vapor from the molecular matrix-residing chlorine dioxide composition.

6. The method of claim 1, wherein:
the molecular matrix-residing chlorine dioxide composition is supplied in a water-soluble package.

7. The method of claim 1, wherein:
the molecular matrix-residing chlorine dioxide composition is supplied in a unit dose water-soluble package comprising one or more food-safe components.

8. The method of claim 1, wherein:
the treatment composition comprises one or more surfactants.

9. The method of claim 1, wherein:
the treatment composition comprises one or more components adapted to enhance soil removal.

10. The method of claim 1, wherein:
the treatment composition comprises one or more components adapted to enhance wetting of surfaces.

11. The method of claim 1, wherein:
the treatment composition comprises one or more coating formulations.

12. The method of claim 1, wherein:
the treatment composition comprises an insecticide.

13. The method of claim 1, wherein:
the treatment composition comprises a chlorine dioxide vapor.

14. The method of claim 1, wherein:
the predetermined target is water that contacts the plurality of harvested crop items.

15. The method of claim 1, wherein:
the predetermined target is water that transports the plurality of harvested crop items.

16. The method of claim 1, wherein:
the predetermined target is water used for processing the plurality of harvested crop items.

17. The method of claim 1, wherein:
the predetermined target is water that cools the plurality of harvested crop items.

18. The method of claim 1, wherein:
the predetermined target is an exterior surface of each of the plurality of harvested crop items.

19. The method of claim 1, wherein:
the predetermined target is soil adhering to an exterior surface of a harvested crop item from the plurality of harvested crop items.

20. The method of claim 1, wherein:
the predetermined target is one or more surfaces of equipment used to process and/or handle the plurality of harvested crop items.
